(19) United States
(12) Patent Application Publication
(10) Pub. No.: US 2026/0065661 A1
(43) Pub. Date: Mar. 5, 2026

(54) SEMI-SUPERVISED SYMBOL DETECTION FOR PIPING AND INSTRUMENTATION DRAWINGS

(71) Applicants: Mohit Gupta, Palo Alto, CA (US); Thomas Czerniawski, Toronto (CA)

(72) Inventors: Mohit Gupta, Palo Alto, CA (US); Thomas Czerniawski, Toronto (CA)

(73) Assignee: Arizona Board of Regents on Behalf of Arizona State University, Scottsdale, AZ (US)

(21) Appl. No.: 19/317,958

(22) Filed: Sep. 3, 2025

Related U.S. Application Data
(60) Provisional application No. 63/691,216, filed on Sep. 5, 2024.

(51) Int. Cl. G06V 10/82; G06V 10/25; G06V 10/426; G06V 10/74; G06V 10/764; G06V 10/774; G06V 30/422

(52) U.S. Cl. CPC G06V 10/82; G06V 10/25; G06V 10/426; G06V 10/761; G06V 10/764; G06V 10/774; G06V 30/422

(57) ABSTRACT

An artificial intelligence-based method for interpreting Piping and Instrumentation Diagram (P&ID) sheets is disclosed. The method includes obtaining a plurality of P&ID sheets in digital format and localizing symbols therein by generating bounding boxes. The localized symbols are labeled as a single generic class to generate a training dataset. A self-supervised learning process trains an artificial intelligence model using the training dataset to identify distinctive symbol features by minimizing the distance between embeddings of similar symbols while maximizing the distance between dissimilar ones. The trained model generates predictive output describing symbols in new P&ID sheets not used in training. The predictive output is then presented for further use.

### CLAIM OF PRIORITY

This application claims the benefit of U.S. Provisional Patent Application No. 63/691,216, filed Sep. 5, 2024, the entire contents of which is incorporated herein by reference.

### TECHNICAL FIELD

Aspects of the invention relate generally to the fields of machine learning (ML), artificial intelligence (AI), and computer vision. More particularly, the disclosure relates to techniques for processing engineering diagrams, including piping and instrumentation diagrams.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to aspects of the claimed inventions.

Piping and instrumentation diagrams (P&IDs) are technical schematics used in industries such as chemical processing, power generation, and water treatment to illustrate the interconnection of process equipment, piping, instrumentation, and control systems.

These diagrams typically include standardized symbols and notations to represent valves, sensors, controllers, pumps, compressors, and other components in a process system. Standards such as those published by the International Society of Automation (ISA) and the American National Standards Institute (ANSI) define these symbols and notational conventions.

P&IDs are often created using computer-aided design (CAD) tools or are scanned from physical records. Their structure supports design validation, process control planning, maintenance workflows, and compliance documentation across a variety of industries.

### SUMMARY

This disclosure is directed to systems and methods for training an artificial intelligence model to automatically detect and differentiate among graphical symbols in piping and instrumentation diagram (P&ID) sheets. A computer system obtains a collection of P&ID sheets in digital form and localizes symbols within them by generating bounding boxes. Rather than assigning unique labels to each type of symbol, all localized symbols are initially labeled as a single generic class. These generic-labeled symbols are used to construct a training dataset, which serves as the basis for self-supervised learning. The AI model is trained to learn distinctive visual features of the symbols by minimizing the distance between embeddings of similar symbols while maximizing the distance between those of dissimilar symbols. Once trained, the model is applied to previously unseen P&ID sheets to generate predictive outputs describing the symbols they contain. These outputs are then provided as part of the system's automated interpretation of the diagrams.

In at least one example, processing circuitry is configured to perform a method including obtaining, by a computer system, a plurality of Piping and Instrumentation Diagram (P&ID) sheets in a digital format. According to certain examples, the method includes localizing symbols from the P&ID sheets by generating bounding boxes for the symbols. In at least one example, the method includes labeling the symbols localized from the P&ID sheets as a single generic class. According to such examples, the method includes generating a training dataset using the symbols localized from the P&ID sheets and labeled as the single generic class. In one example, the method includes training, by the computer system, an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols. According to certain examples, the method includes generating predictive output using the artificial intelligence model trained on the training dataset for describing symbols within a new P&ID sheet which forms no part of the training dataset. In at least one example, the method includes outputting the predictive output.

In one example, the system includes processing circuitry and non-transitory computer readable media. According to certain examples, the system further includes instructions that, when executed by the processing circuitry, configure the processing circuitry to obtain a plurality of Piping and Instrumentation Diagram (P&ID) sheets in a digital format. In at least one example, the system includes instructions to localize, by the processing circuitry, symbols from the P&ID sheets by generating bounding boxes for the symbols. According to such examples, the system includes instructions to label, by the processing circuitry, the symbols localized from the P&ID sheets as a single generic class. In one example, the system includes instructions to generate, by the processing circuitry, a training dataset using the symbols localized from the P&ID sheets and labeled as the single generic class. According to certain examples, the system includes instructions to train, by the processing circuitry, an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols. In at least one example, the system includes instructions to generate, by the processing circuitry, predictive output using the artificial intelligence model trained on the training dataset for describing symbols within a new P&ID sheet which forms no part of the training dataset. According to such examples, the system includes instructions to output, by the processing circuitry, the predictive output.

In one example, non-transitory computer-readable storage media comprises instructions that, when executed, configure processing circuitry to obtain a plurality of Piping and Instrumentation Diagram (P&ID) sheets in a digital format. According to certain examples, the computer-readable storage media includes instructions to localize symbols from the P&ID sheets by generating bounding boxes for the symbols. In at least one example, the instructions configure the processing circuitry to label the symbols localized from the P&ID sheets as a single generic class. According to such examples, the computer-readable storage media includes instructions to generate a training dataset using the symbols localized from the P&ID sheets and labeled as the single generic class. In one example, the instructions further configure the processing circuitry to train an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols. According to certain examples, the computer-readable storage media includes instructions to generate predictive output using the artificial intelligence model trained on the training dataset for describing symbols within a new P&ID sheet which forms no part of the training dataset. In at least one example, the instructions further configure the processing circuitry to output the predictive output.

In a particular example, there is a device comprising means for obtaining a plurality of Piping and Instrumentation Diagram (P&ID) sheets in a digital format. The device includes means for localizing symbols from the P&ID sheets by generating bounding boxes for the symbols. The device includes means for labeling the symbols localized from the P&ID sheets as a single generic class. The device includes means for generating a training dataset using the symbols localized from the P&ID sheets and labeled as the single generic class. The device includes means for training an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols. The device includes means for generating predictive output using the artificial intelligence model trained on the training dataset for describing symbols within a new P&ID sheet which forms no part of the training dataset. The device includes means for outputting the predictive output.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating one example of a computing device configured to implement a symbol detection framework, in accordance with aspects of the disclosure.

FIGS. 2A, 2B, 2C, and 2D illustrate a sampling of the diverse drawing styles represented within the dataset used by the symbol detection framework, in accordance with aspects of the disclosure.

FIGS. 3A and 3B illustrate an overview of the process for making piping and instrumentation diagrams queryable with natural text, in accordance with aspects of the disclosure.

FIG. 4 illustrates an example mapping of P&ID symbols into corresponding graph-based entities within base entity graph nodes, in accordance with aspects of the disclosure.

FIG. 5 illustrates an information retrieval system that interfaces a user with a labeled property graph, in accordance with aspects of the disclosure.

FIG. 6A illustrates example processing of a piping and instrumentation diagram (P&ID) sheet by dividing it into non-overlapping crops of uniform sizes, in accordance with aspects of the disclosure.

FIG. 6B depicts valve symbol crops, which include an example of different but visually similar looking symbols in piping and instrumentation drawings detectable using a symbol detection framework, in accordance with aspects of the disclosure.

FIG. 6C illustrates handwritten symbol crops and P&ID symbol crops, in accordance with aspects of the disclosure.

FIG. 7A illustrates an example representation of a typical autoencoder architecture used by a symbol detection framework, in accordance with aspects of the disclosure.

FIG. 7B illustrates a denoising autoencoder architecture for processing engineering diagrams, such as piping and instrumentation diagrams, used within symbol detection framework 170, in accordance with aspects of the disclosure.

FIG. 8 illustrates a vector space representation of a triplet loss learning process used during training of a Siamese network configured for symbol differentiation, in accordance with aspects of the disclosure.

FIG. 9 illustrates an example architecture of a Siamese network utilized by the symbol detection framework, in accordance with aspects of the disclosure.

FIG. 10 illustrates a mAP performance graph showing the comparative training performance of different model initialization strategies used in the symbol detection framework, in accordance with aspects of the disclosure.

FIG. 11 illustrates a mAP performance curve plotted over an x-axis representing training data percentage and a y-axis representing mAP score, in accordance with aspects of the disclosure.

FIG. 12 illustrates Table 1 showing the impact of sampling strategy on model performance when trained on limited subsets of annotated data, in accordance with aspects of the disclosure.

FIGS. 13A and 13B illustrate an embedding space visualization, which plots embedded sample points and coreset sample points across embedding dimensions, in accordance with aspects of the disclosure.

FIG. 14 illustrates Table 2, which summarizes the impact of pseudo-label images in the next iteration on model performance, in accordance with aspects of the disclosure.

FIG. 15 illustrates pseudo-labeling performance on a test set, plotted over an x-axis representing training data used (%) and a y-axis representing model performance (mAP), in accordance with aspects of the disclosure.

FIG. 16 illustrates symbol retrieval results produced by the symbol detection framework, showing performance of the trained Siamese network across multiple query cases, in accordance with aspects of the disclosure.

FIG. 17 depicts instances where the symbol detection framework may require further training or a more diverse dataset due to unsuccessful retrieval from a respective query image, in accordance with aspects of the disclosure.

FIG. 18 is a flow diagram illustrating an example method for training and applying an artificial intelligence (AI) model to identify and differentiate symbols from piping and instrumentation diagram (P&ID) sheets, in accordance with aspects of the disclosure.

Like reference characters denote like elements throughout the text and figures.

### DETAILED DESCRIPTION

Aspects of the disclosure are generally related to systems, methods, and apparatuses for implementing semi-supervised symbol detection for piping and instrumentation drawings.

Current computer vision methods for symbol detection in piping and instrumentation diagrams (P&IDs) face limitations due to the manual data annotation resources they require. The symbol detection framework described herein provides a versatile two-stage symbol detection pipeline that optimizes efficiency by (1) labeling only data samples with minimal cumulative informational redundancy, (2) restricting annotation to the minimal effective training dataset size, and (3) expanding the training dataset using pseudo-labels. According to certain examples, the symbol detection framework includes first and second stages. For instance, stage-1 processing may perform generic symbol detection, while stage-2 processing performs symbol differentiation through metric learning. To enhance robustness and generalizability, the model may be trained on a diverse dataset collected from both industry sources and web scraping.

Experimental testing demonstrated that the symbol detection framework achieves Top-1 accuracy of 85.39%, with a Top-5 accuracy of 95.19% on a test dataset containing 102 symbol classes. These results suggest the potential for a shift from resource-intensive supervised learning approaches to the more efficient semi-supervised paradigm utilized by the symbol detection framework.

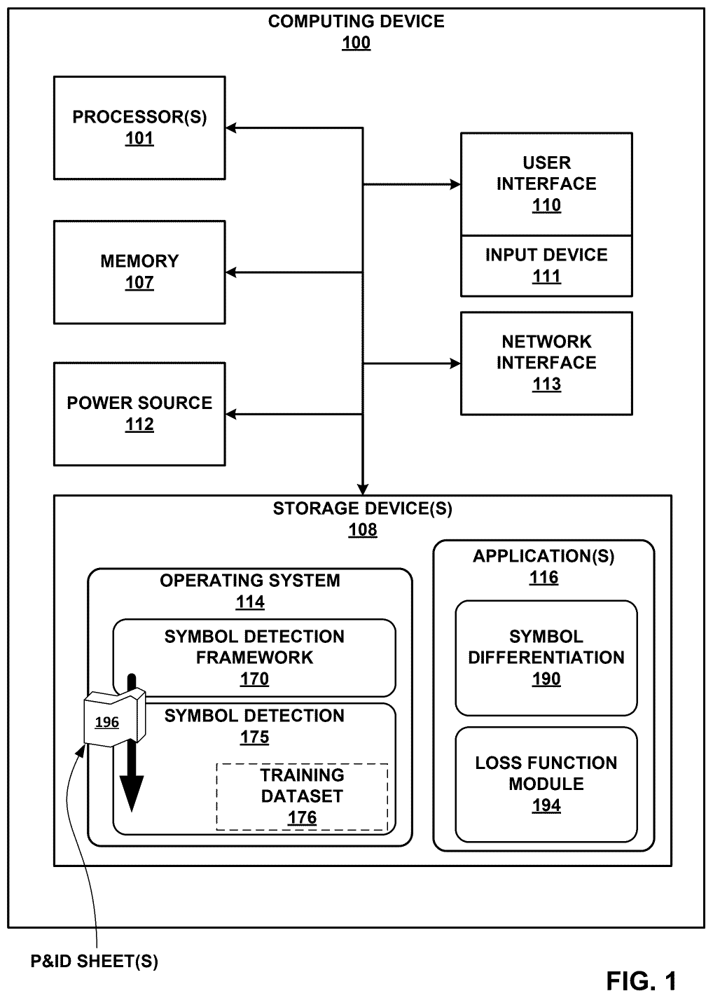

FIG. 1 is a block diagram illustrating one example of a computing device 100 configured to implement symbol detection framework 170, in accordance with aspects of this disclosure. While FIG. 1 illustrates a particular configuration, other examples with varying configurations may also be used to implement aspects of the disclosure.

As shown, computing device 100 may include one or more processors 101, memory 107, one or more storage devices 108, a network interface 113, a user interface 110, and a power source 112. Computing device 100 may also include an operating system 114 and one or more applications 116. Operating system 114 includes symbol detection framework 170, which encompasses symbol detection 175 and training dataset 176. Applications 116 may include modules such as symbol differentiation 190 and apply loss function 194.

Computing device 100 may be configured to process P&ID sheets 196 using symbol detection framework 170. For example, symbol detection framework 170 may receive P&ID sheets 196, detect and localize symbols, and generate new training dataset 176. Symbol detection 175 may be performed using generic classification, while symbol differentiation 190 leverages self-supervised learning to distinguish symbol classes without manual labeling. Loss function module 194 may apply appropriate loss functions during training of an AI model.

Processor(s) 101 may execute instructions stored in memory 107 or storage device(s) 108. These processors may carry out the operations of symbol detection framework 170, such as symbol localization, dataset generation, and self-supervised training.

Memory 107 may temporarily store program instructions or intermediate data used by symbol detection framework 170. It may include volatile memory such as RAM, DRAM, or SRAM. During operation, memory 107 may be used to store models, weights, or intermediate feature maps computed during AI training or inference.

Storage device(s) 108 may include non-volatile memory such as magnetic hard disks, optical discs, flash drives, EEPROM, or other computer-readable media. Storage device(s) 108 may persistently store datasets, symbol annotations, pre-trained models, and other resources used by symbol detection framework 170.

Network interface 113 may allow computing device 100 to receive input P&ID sheets 196 from external sources, such as cloud storage or industrial systems. Network interface 113 may include wired (e.g., Ethernet) or wireless interfaces (e.g., Wi-Fi®, BLUETOOTH®, LTE, 5G), and may also support data exchange with other systems for training dataset sharing or inference deployment.

User interface 110 may include input device(s) 111, such as touchscreens, keyboards, or microphones, and output devices such as displays or speakers. A user may interact with the symbol detection framework 170 via user interface 110, for example, to upload P&ID sheets, review detection results, or modify model parameters.

Power source 112 may supply power to computing device 100. It may include a rechargeable battery, such as a lithium-ion battery, or other energy sources suitable for the deployment environment.

Operating system 114 may facilitate coordination between the hardware components and symbol detection framework 170, managing memory, processor access, and system resources.

Operating system 114 includes symbol detection framework 170. Applications 116 may include modules that implement symbol differentiation 190, loss function module 194, AI algorithms, data preprocessing, and pseudo-label generation. In one example, symbol detection framework 170 performs generic symbol detection and applies self-supervised learning to differentiate symbols across varied P&ID drawing styles, significantly reducing the need for manual labeling. Symbol detection framework 170 may apply loss functions via loss function module 194, including focal loss or contrastive loss, during AI model training to improve symbol recognition performance.

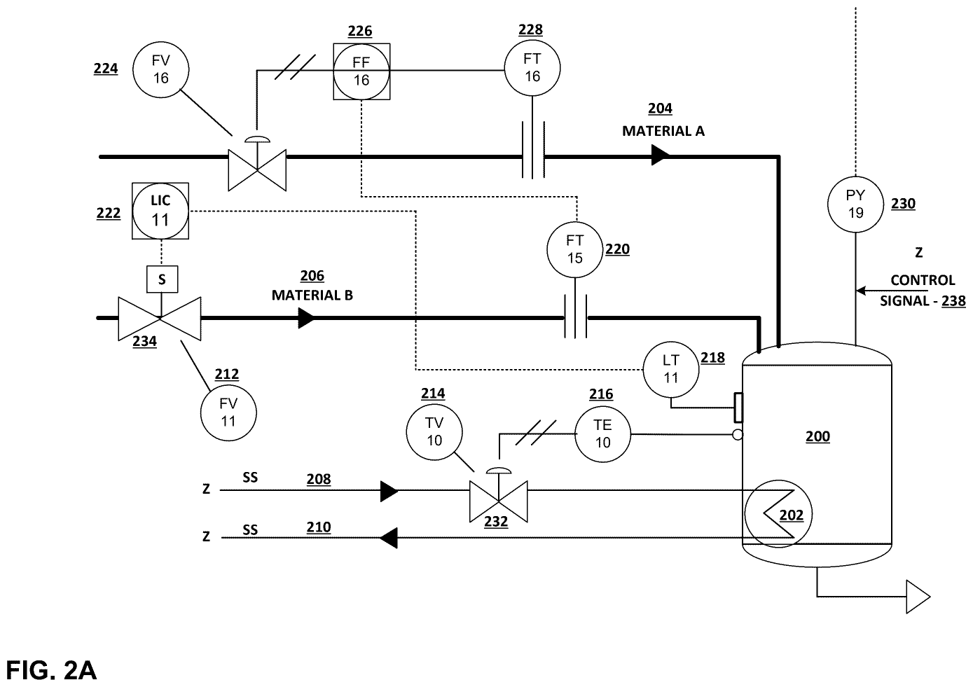

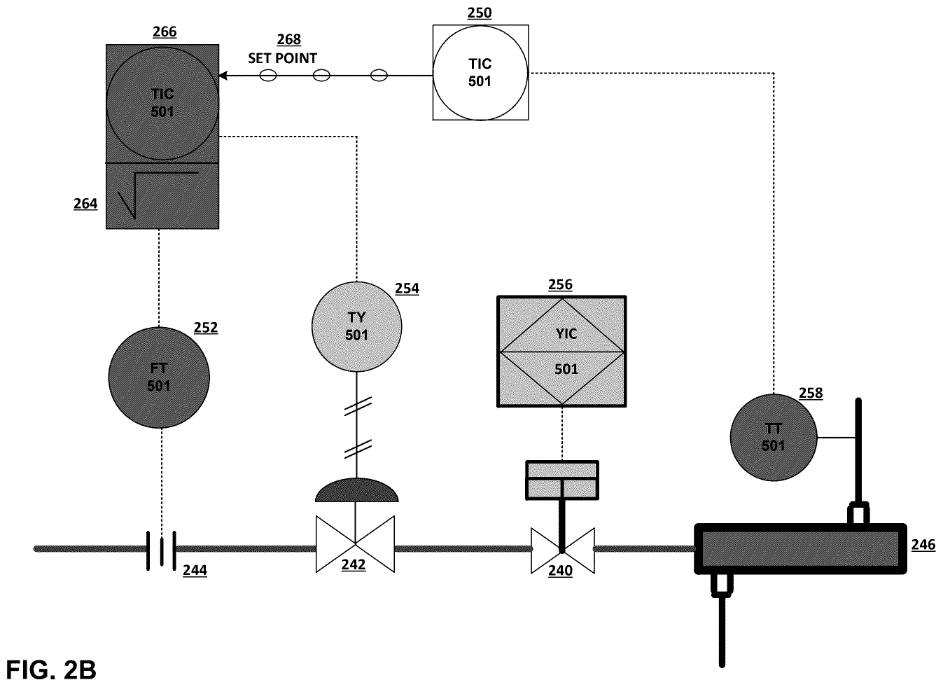

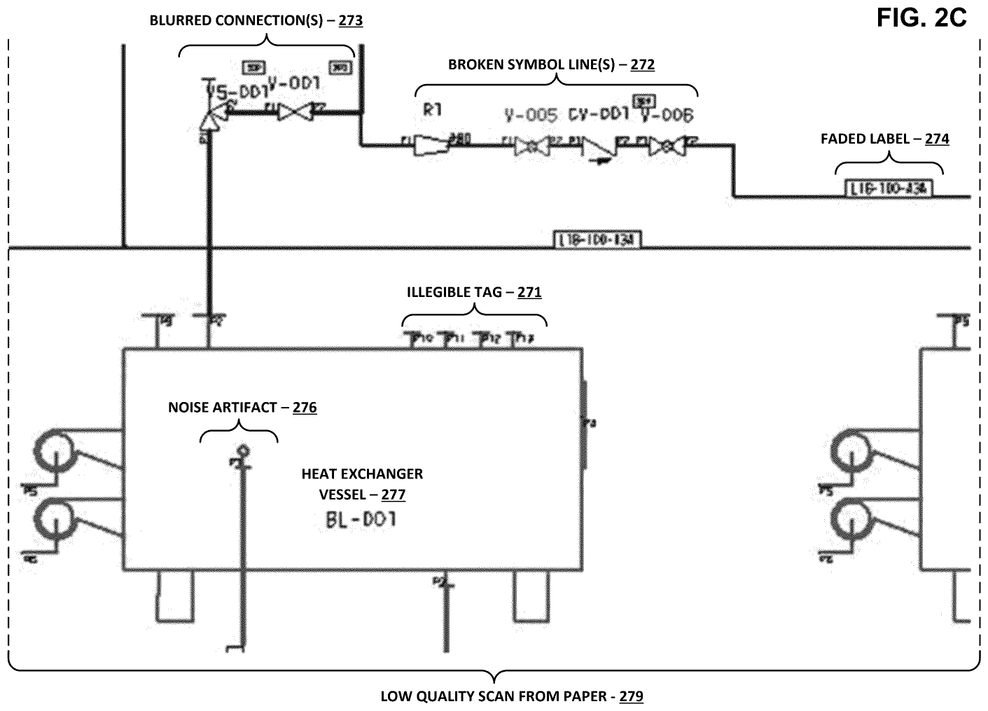

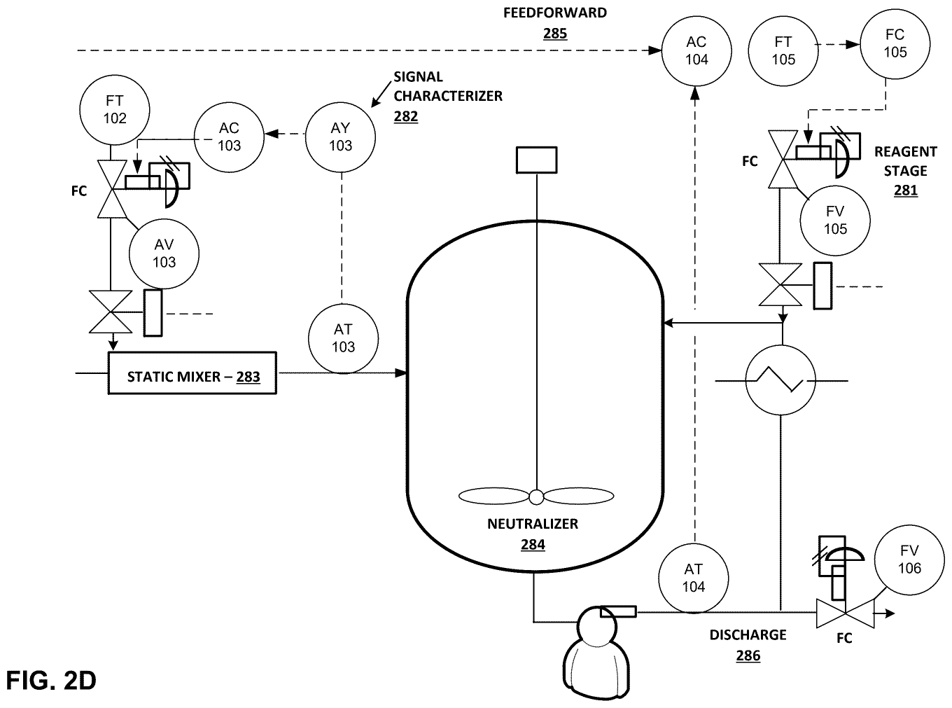

FIGS. 2A, 2B, 2C, and 2D illustrate a sampling of the diverse drawing styles represented within the dataset used by symbol detection framework 170, in accordance with aspects of this disclosure. These example P&ID sheets highlight variability in visual quality, annotation density, drawing format, and symbol labeling schemes. The depiction across FIGS. 2A-2D enables the development of a more robust symbol detection algorithm that generalizes effectively across styles and domains.

It should be noted that numeric values such as “11,” “501,” and “TV 10,” are shown within various symbol labels across FIGS. 2A-2D, are not reference numerals used in this specification. Instead, they represent domain-specific identifier values or tag names used within P&ID standards. For example, “AT 501” denotes a standard instrument tag referencing an analytical transmitter with identifier 501, while “TV 10” references a temperature valve assigned identifier 10. These tags are present in the figures for authenticity and relevance to real-world schematics but are not cited with reference numerals.

FIG. 2A illustrates a process vessel 200 configured to receive material A 204 and material B 206 as inputs. Material A 204 passes through flow valve 224 into flow feedforward 226 and subsequently through flow transmitter 228. Flow feedforward 226 receives level control feedback from level indicator controller 222. Level indicator controller 222 is in communication with level transmitter 218 and operates flow valve 234, thereby influencing the inlet of material B 206. Material B 206 flows through flow transmitter 220 prior to entry into process vessel 200. The temperature of the incoming stream is regulated by temperature valve 214, which receives input from temperature element 216. Source stream 208 enters the system and is directed through temperature valve 232 into process vessel 200. Return stream 210 exits the process vessel 200 through temperature valve 232. A heat exchanger 202 is incorporated within process vessel 200 to maintain thermal regulation. Control signal 238 originating from process vessel 200 is transmitted to pneumatic relay 230 to facilitate process feedback.

FIG. 2B illustrates a process control loop centered on process stream 244. Process stream 244 flows through flow valve 242 and subsequently through flow valve 240 before reaching heat exchanger 246. Flow transmitter 252 monitors flow in process stream 244 and transmits measurements to temperature indicator controller 266. Temperature indicator controller 266 is associated with controller element 264. Temperature indicator controller 266 receives a set point signal via set point 268, which originates from temperature indicator controller 250. Temperature indicator controller 266 interfaces with instrument relay TY 501 at 254 and with instrument controller YIC 501 at 256. Instrument relay TY 501 provides control input to flow valve 242. Instrument controller YIC 501 modulates flow valve 240. Temperature transmitter 258 monitors process temperature in heat exchanger 246 and provides a feedback signal to temperature indicator controller 250. This closed-loop configuration exemplifies a cascaded temperature control system.

FIG. 2C depicts a low-resolution scanned P&ID schematic containing diagrammatic anomalies that challenge traditional symbol detection methods. Heat exchanger vessel 277 appears centrally within the figure. Illegible tag 271 is shown along the upper portion of heat exchanger vessel 277, where character resolution is insufficient for recognition. Broken symbol line(s) 272 interrupt continuity between adjacent valve symbols and associated pipeline segments. Blurred connection(s) 273 appear in the upper left region near valve symbols, contributing to ambiguous topology. Faded label 274 is situated along the upper right side of the figure. Noise artifact 276, possibly due to scanning interference or ink distortion, is present in the vicinity of heat exchanger vessel 277. The overall degradation is attributable to low quality scan from paper 279, which introduces visual noise and affects recognizability of individual elements.

FIG. 2D illustrates a digitally rendered P&ID representing a signal conditioning and neutralization system. In this configuration, reagent stage 281 introduces reagent into a process stream. Reagent stage 281 includes flow controller 105, flow transmitter 105, and flow valve 105, representing standard P&ID labeling practices where identical identifier tags may be repeated for related instruments. These values are real-world tag names and not reference numerals. Reagent stage 281 is connected to analyzer controller AC 104, which modulates reagent flow. A signal characterizer 282 receives input from analyzer controller AC 103 and further connects to analyzer relay AY 103 and analyzer transmitter AT 103, establishing a signal processing chain. A feedforward 285 path carries output from analyzer controller AC 103 to analyzer controller AC 104. The treated material flows into static mixer 283, which blends the stream and outputs to neutralizer 284. Neutralizer 284 receives control input from analyzer transmitter AT 103 and analyzer transmitter AT 104. System output is monitored at discharge 286. Downstream of discharge 286 is a discharge outlet incorporating flow controller and flow valve 106, which regulate final outflow.

The depicted figures collectively represent diverse drawing styles, visual qualities, symbol complexities, and annotation formats. These differences reinforce the need for generalized symbol detection techniques. Symbol detection framework 170 accounts for these variations and is specifically designed to analyze and interpret schematics like those shown in FIGS. 2A through 2D.

The following sections provide additional context regarding P&ID usage and existing symbol detection approaches, to frame the challenges addressed by symbol detection framework 170.

### Introduction

Piping and instrumentation diagrams (P&IDs) are technical drawings used to operate and maintain process systems. They depict the piping and related components, illustrating their interconnections. Symbols in P&ID sheets represent system components such as pumps, tanks, valves, control devices, temperature sensors, and flow meters. In completed projects, P&IDs serve as references for understanding the layout and operation of process systems, which aids in maintenance or repairs. For ongoing projects, procurement teams utilize P&IDs to identify required components and their quantities. This information is helpful with preparing bills of quantities, placing purchase orders, developing work schedules, and performing resource allocation.

Specialized authoring programs are employed to create P&IDs. However, due to contractual obligations and intellectual property concerns, P&ID diagrams are often shared as rasterized images or PDFs. Moreover, existing facilities often have P&IDs that were manually created and are stored as PDFs of scanned paper drawings. The image and rasterized formats of these documents do not allow semantic-aware editing, leading to predominantly manual information extraction. To address this, symbol detection framework 170 provides computer vision-based methods to automate the analysis of P&ID documents and extract useful information, such as component detection and classification. Symbol detection framework 170 may be utilized to effectively identify and localize various components including symbols, text, and pipelines within P&ID diagrams, regardless of whether they are in a source format, PDF format, or scanned from printed documents. Such components may then be used for tasks such as creating asset databases, developing maintenance schedules, and digitizing scanned P&IDs.

Machine learning (ML) methods for symbol classification and detection in P&IDs are typically trained on single-source (e.g., single domain) datasets. Thus, while a resulting AI model trained on the single-source dataset may be optimized for a specific drawing style, the same AI model may not generalize well to P&IDs with different drawing styles. This limitation is significant because P&IDs vary across companies in the process industry and may utilize P&IDs having differing drawing styles. Even a single company may have P&IDs with different and inconsistent drawing styles due to factors such as acquiring other companies or plants with different styles, operating in different regions with varying standards, using different designers with preferred styles, or utilizing different software to create the original P&IDs.

With reference to the variability illustrated in FIGS. 2A-2D, existing machine learning approaches have been limited in their ability to generalize across such diverse inputs. Existing machine learning techniques require annotated data for each symbol class, thus limiting the number of detectable symbol classes such techniques are able to detect. Detecting new symbols with prior known techniques necessitates additional training data and annotations, which can be time-consuming and costly. One potential approach involves the curated development of multiple project-specific machine learning models. However, such an option is expensive due to the costs associated with creating, running, and maintaining multiple machine learning models.

Another approach is to create a large dataset encompassing various P&ID drawing styles with numerous annotated symbol classes. However, such an approach is also costly as it requires significant skilled human effort to correctly annotate and track the many symbol classes.

To address these challenges, symbol detection framework 170 provides a two-stage symbol detection method trained on a large dataset to improve robustness and generalizability. Use of symbol detection framework 170 reduces the need for costly human annotation by leveraging self-supervised techniques. Several experiments were conducted to explore how the machine learning pipeline embodied by symbol detection framework 170 successfully minimizes human data annotation. These experiments include leveraging pre-existing annotated data through transfer learning, labeling only the data samples that minimize cumulative informational redundancy, limiting annotation to the minimal effective training dataset size, and expanding the training dataset using pseudo-labels.

Symbol detection framework 170 utilizes techniques for analyzing P&IDs including methods for the recognition and classification of symbols, pipelines, and text, as well as the inference of their interconnectivity relationships. Such methods enable integration between image processing techniques with machine learning and deep learning-based algorithms.

### Symbols Detection:

Existing symbol detection techniques utilize heuristic-based methods for circular symbol recognition using the Hough Transform. Template matching methods have also been employed for symbol recognition. Additionally, rule-based methods for segmenting symbols in line drawings define criteria such as edge length and the number of connections at a node to distinguish symbols. However, these heuristic and rule-based methods may be less robust as the techniques are highly susceptible to noise and slight variations in the dataset, which can adversely affect their performance.

Neural network-based algorithms from machine learning and computer vision disciplines have been explored, including training models with iterative learning rules using the Hopfield model. Popular object detection algorithms, such as Yolo, have been applied for symbol localization. R-CNN and Faster R-CNN have been used for symbol localization, while CNNs based on AlexNet have been utilized for symbol recognition. Techniques such as generalized focal loss have been employed to address class imbalance, and ArcFace loss has been used to generate discriminative embeddings. The use of Fully Convolutional Networks (FCNs) has been proposed to improve performance in differentiating similar-looking symbols compared to bounding box-based methods. Two-stage methods involving FCNs for region proposal followed by classification with TBMSL-net have also been developed.

Supervised learning algorithms learn from labeled data, where each training example is paired with an output label. The goal of training the AI model is to learn a mapping from inputs to outputs based on these examples. For instance, during training, an AI algorithm receives input-output pairs and adjusts its parameters to minimize the difference between its predictions and the actual labels. The performance is evaluated using metrics such as accuracy, precision, recall, or mean squared error.

The above techniques utilize supervised learning algorithms, which are limited to identifying only those classes for which labeled training data is available. To extend such supervised learning algorithms to additional symbol classes, acquiring more labeled data will be necessary.

Conversely, unsupervised learning algorithms and self-supervised learning algorithms work with unlabeled data. Unsupervised learning and self-supervised learning represent two distinct approaches in machine learning, each characterized by its methodologies and applications.

Unsupervised learning involves training models on datasets that lack labeled responses. The goal of training the AI model is to find hidden patterns or intrinsic structures within the data without explicit guidance. For instance, the AI algorithm identifies patterns, clusters, or structures in the data based on the inherent similarities and differences. Evaluation is often done through metrics like cluster quality or dimensionality reduction effectiveness.

Clustering involves grouping similar data points together, which can be used to segment customers into distinct groups based on their purchasing behavior. Dimensionality reduction aims to minimize the number of features while preserving important information, as demonstrated by Principal Component Analysis (PCA), which simplifies high-dimensional data for easier visualization. Anomaly detection focuses on identifying unusual or outlier data points, such as detecting fraudulent transactions within financial datasets. Examples of unsupervised learning algorithms used in these techniques include K-Means Clustering, which partitions data into k clusters based on feature similarity, and Hierarchical Clustering, which constructs a tree of clusters based on distances between data points. Principal Component Analysis (PCA) reduces data dimensionality by finding principal components that capture the most variance, while Auto-encoders are neural networks designed to encode data into a lower-dimensional space and then decode it back.

Self-supervised learning, on the other hand, involves AI models generating their own labels from the data itself, thus creating supervisory signals without the need for external labels. This approach may serve as a bridge between supervised and unsupervised learning. A prominent aspect of self-supervised learning is pretext tasks, where models are trained to solve problems indirectly related to the main task, such as predicting missing parts of an image or the next word in a sentence. Contrastive learning involves learning representations by comparing similar and dissimilar pairs of data, enabling the model to distinguish between similar and different data points through contrasting views of the same object.

The auto-encoders are neural networks designed to encode data into a lower-dimensional space and then decode it back to its original form, aiding the model in learning efficient data representations. Variants include denoising auto-encoders and variational auto-encoders. Additionally, generative models like Generative Adversarial Networks (GANs) may be utilized with self-supervised learning to create or complete data samples, with the model learning to generate data similar to the training data by comparing generated samples to real ones.

Notably, the unsupervised learning algorithms and self-supervised learning algorithms do not require labeled data, making them suitable for exploratory data analysis or scenarios where labels are unavailable, infeasible, limited in quantity and/or scope, or costly to obtain, as effectiveness of such algorithms depends on the inherent structure of the data itself.

Unlike prior known techniques, symbol detection framework 170 in at least one example utilizes a two-stage symbol detection method to generate a suitably trained AI model. Such an AI model may be trained on a large multi-domain dataset to further enhance robustness and generalizability. Symbol detection framework 170 reduces the need for costly human annotation by leveraging self-supervised techniques. Several experiments were conducted to explore ways the machine learning pipeline can minimize manual data annotation. These experiments include leveraging pre-existing annotated data through transfer learning, labeling only data samples that minimized cumulative informational redundancy, limiting annotation to the minimal effective training dataset size, and expanding the training dataset using pseudo-labels.

According to certain examples, symbol detection framework 170 implements a two-stage semi-supervised technique for symbol detection to increase generalization across different P&ID drawing styles and symbolic representations.

Semi-supervised learning provides a hybrid approach that integrates elements from both supervised and unsupervised learning paradigms. For instance, models may be trained using a dataset comprising a small quantity of labeled data alongside a large volume of unlabeled data with the objective of utilizing the unlabeled data to enhance the performance and generalizability of the resulting trained AI model. In such a way, semi-supervised learning leverages the limited labeled data for model guidance while exploiting the extensive unlabeled data to refine the learning process. The labeled data provides explicit supervision, facilitating an understanding of the relationship between inputs and outputs. Meanwhile, the unlabeled data facilitates the AI model learning the underlying structure of the data distribution, which can enhance predictions by the trained AI model and the ability of the AI model to generalize to new, unseen examples.

For example, symbol detection framework 170 may label all classes as a single class, subsequent to which, differentiation is achieved through self-supervised learning, significantly reducing the cost and complexity of human annotation. An experimental study determined the effectiveness of training a symbol detection model from scratch versus using transfer learning with three different pretrained networks, evaluating performance through convergence speed and mean average precision (mAP).

An investigative study into the diminishing returns of annotation on model performance revealed that performance gains do not exhibit a linear relationship with the amount of labeled data, informing decisions about annotation needs and resource optimization. For instance, one experiment comparing different sampling methods for training data selection demonstrated that sampling techniques such as simple random sampling and K-means coreset sampling yield varying model performance, allowing for more precise and economical data point selection. Additionally, the use of pseudo-labels demonstrably increases the training dataset size without additional costs or human annotations.

### Text Detection:

Text detection in P&ID sheets may include identifying strings of alphanumeric characters representing equipment codes or functions. For instance, within a two-stage framework, a first stage may involve identifying regions in the image where text is likely to be present, with the second stage confirming the presence of text in these regions while reducing false positives. Various methods for text detection include shape matching techniques, rule-based criteria, connected component analysis, and the use of models like Connectionist Text Proposal Network (CTPN) and Character Region Awareness for Text Detection (CRAFT). For instance, one approach utilized a shape-matching technique to detect text in vectorized documents using rule-based criteria to generate text proposal regions and compare characters to a database. Another technique defined rules on aspect ratio for generating text proposal regions and applied OCR for detection. Yet another technique suggested using connected component analysis for text segmentation while in practice, use of connected components were found to be overly sensitive to noise. Connectionist Text Proposal Network (CTPN) for may be applied for text proposals and Tesseract for recognition, with similar approaches including the easyOCR framework for text region generation and CTPN for text recognition. However, experiments have shown that CTPN does not reliably detect vertical text components. Other techniques include application of the Character Region Awareness for Text Detection (CRAFT) for text region proposals and Tesseract for text reading.

The effectiveness of these methods varies, with some unable to reliably detect vertical text components or requiring extensive parameter tuning.

Pipeline Detection and Connectivity Information: Pipelines are represented by solid lines and dashed lines of varying thicknesses. The P&ID type diagrams in particular have not been comprehensively analyzed, sufficient to reliably associate detected symbols, pipelines, and textual tags. While some techniques exist for symbol and text detection, accuracy of such techniques with pipeline detection and association with textual tags is not satisfactory for P&ID diagrams.

Rule-based image processing may be applied to detect lines (pipelines), for instance, thresholding line lengths for pipeline classification or using a Probabilistic Hough Transform. However, each results in low accuracy pipeline detection when applied to P&ID type diagrams. Moreover, the Hough Transform requires extensive parameter tuning and is not reliable for efficient pipeline detection in noisy P&IDs. One approach utilized heuristics based on Euclidean distance to derive associations among detected P&ID elements and create a tree-based representation resulting in high accuracy in detecting symbols and text, but low accuracy in detecting pipelines and associating textual tags with pipelines. Still other techniques attempted to map detected elements using Euclidean distance to derive interconnectivity relationships.

For instance, some methods recognized one symbol class using three P&ID sheets, while others used four sheets to detect ten classes of symbols or synthetic datasets to detect 32 classes. However, such single-domain training datasets, with uniform drawing styles, are prone to overfitting and are less generalizable to new P&ID styles. One multi-domain training dataset having multiple P&ID standards detected 76 symbol classes, but required extensive manual annotation and is therefore considered infeasible to scale.

Such currently known techniques all have limitations when applied to P&ID type diagrams, such as susceptibility to overfitting and lack of generalizability due to uniform drawing styles in the training datasets utilized by the prior techniques. To overcome these challenges, symbol detection framework 170 simplifies and reduces the annotation process using self-supervised learning, demonstrating through the experiments discussed below that symbol detection framework 170 is capable of detecting a large number of symbol classes across diverse P&ID drawing styles.

Conversely, symbol detection framework 170 demonstrably outperforms all prior known techniques with respect to symbol detection, capable of identifying more symbols and detecting a large number of classes across multiple domains and diverse P&ID drawing styles while utilizing a reduced and simplified annotation process through the application of self-supervised learning.

### Methodology:

As described herein, symbol detection framework 170 implements an improved methodology for detecting symbols on P&ID sheets. According to certain examples, symbol detection framework 170 involves two stages: 1) performing generic symbol detection and 2) differentiating symbols using a Siamese Network. The first stage focuses on localizing all symbols on the P&ID sheets, while the second stage aims to learn distinctive features to differentiate among the symbols detected.

To create the training dataset, all symbols were labeled as a single generic class. This approach facilitates the rapid generation of a labeled dataset as there is no need for human interaction as all detected symbols are simply grouped into a single generic class. Subsequently, symbol detection framework 170 applies self-supervised learning to the labeled dataset for symbol differentiation, eliminating the need for costly and time-consuming manual labeling of each symbol class.

Symbol detection framework 170 next creates a new training dataset creation and applies data preprocessing.

### Dataset Creation:

In one example, a dataset including 92 distinct P&ID sheets was compiled from industry partners and web scraping. The example dataset encompassed a broad array of drawing styles and symbols, from which a robust symbol detection algorithm was developed, capable of generalizing to new data which formed no part of the training dataset. While specific classes of symbols were not manually annotated, it is estimated that there were over 200 symbol classes established by symbol detection framework 170 through the self-supervised learning operations. The number of symbols per sheet varied based on the specific details and size of the drawings, ranging from 18 to 177 symbols per sheet, resulting in a total of 4,344 symbol instances.

With reference again to FIGS. 2A-2B, each of the distinct P&ID sheets illustrates the diversity of the many drawing styles present in the dataset. A large multi-source/multi-domain dataset was utilized to reduce biases and prevent overfitting, which can be a problem when using a small dataset from a single source. Overall, the diversity and variety of the improves generalization of the algorithm to different types of P&ID sheets and symbols. Of the 92 P&ID sheets, the training dataset included 72 randomly selected P&ID sheets, with the remaining 20 sheets being set aside for testing.

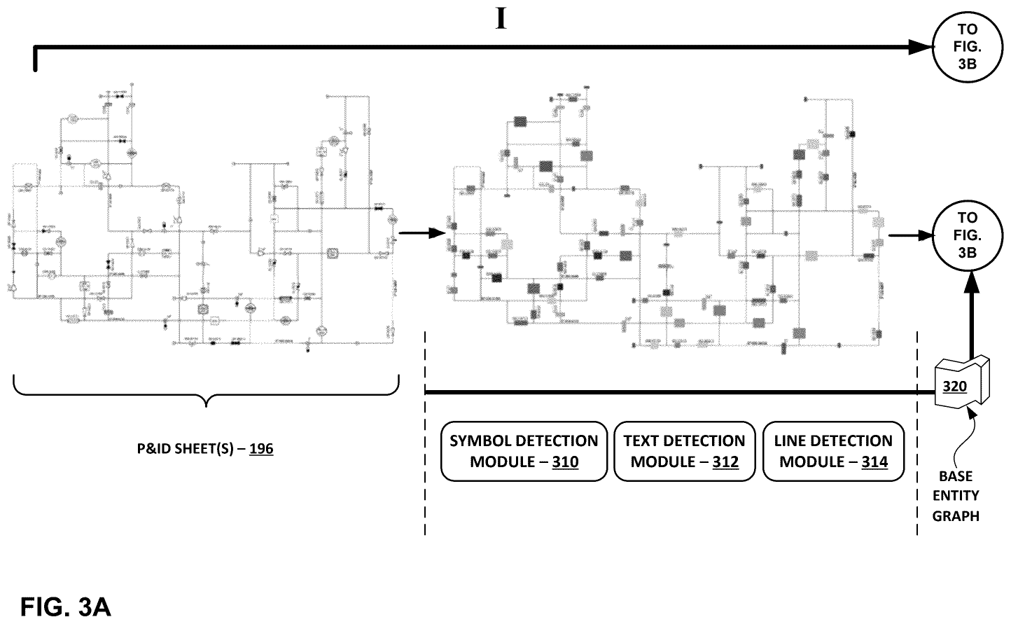

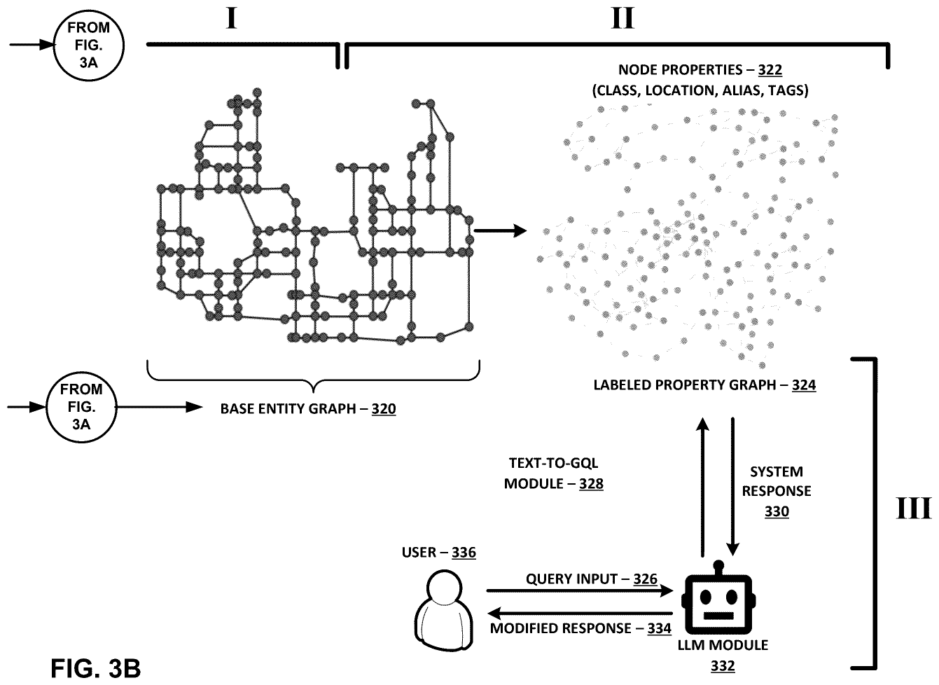

FIGS. 3A and 3B illustrate an overview of the process for making piping and instrumentation diagrams queryable with natural text, in accordance with aspects of the disclosure. The method consists of three steps: Step I includes creation of a base entity graph, Step II includes transformation into a labeled property graph, and Step III includes an information retrieval system that interfaces a user with the knowledge graph.

With reference to FIG. 3A, P&ID sheet(s) 196 are first digitized to generate structured representations. Symbol detection module 310, text detection module 312, and line detection module 314 each process P&ID sheet(s) 196 to detect respective elements. Symbol detection module 310 detects symbols using an object detection model trained on image tiles. Text detection module 312 recognizes textual components using an OCR model tuned to P&ID label styles. Line detection module 314 applies a custom method combining a probabilistic Hough transform with post-processing to identify pipelines and eliminate duplicate segments. Outputs of symbol detection module 310, text detection module 312, and line detection module 314 are aggregated to generate base entity graph 320.

The process of creating base entity graph 320 occurs in two stages. In a first stage, entity recognition is performed. Symbols are detected by training a YOLOv11 object detection model using an image-tiling approach, where P&ID sheet(s) 196 are divided into overlapping tiles to improve detection accuracy. Text is detected using a KerasOCR model fine-tuned on a training set of P&ID images. Lines are recognized with the probabilistic Hough transform, where hyperparameters are programmatically selected, combined with a post-processing stage that merges duplicate line segments. In a second stage, graph-based linking connects entities into a graph. Symbols form a first set of nodes, line crossings form a second set of nodes, and line segments connect nodes into edges. Detected text is associated with symbols or pipelines using proximity matching and regular expressions. Base entity graph 320 is implemented using the NetworkX Python library and is checked for errors using semi-automatic rules with human-in-the-loop correction, ensuring graph quality prior to subsequent processing.

As shown in FIG. 3B, base entity graph 320 is transformed into a more expressive representation by appending node properties 322. Node properties 322 include class, location, alias, and tags, producing labeled property graph 324. Labeled property graph 324 captures both the topology and the semantic attributes of detected P&ID elements.

Text-to-GQL module 328 receives query input 326 from user 336. Query input 326 may include natural language text seeking information about P&ID sheet(s) 196. Text-to-GQL module 328 converts query input 326 into a graph query language compatible with labeled property graph 324. System response 330 generated from labeled property graph 324 is provided to LLM module 332. LLM module 332 interprets system response 330, contextualizes results, and outputs modified response 334 in natural language. Modified response 334 is then returned to user 336.

Together, P&ID sheet(s) 196, symbol detection module 310, text detection module 312, line detection module 314, base entity graph 320, node properties 322, labeled property graph 324, query input 326, text-to-GQL module 328, system response 330, LLM module 332, modified response 334, and user 336 illustrate a complete end-to-end system for enabling natural language queries against engineering diagrams.

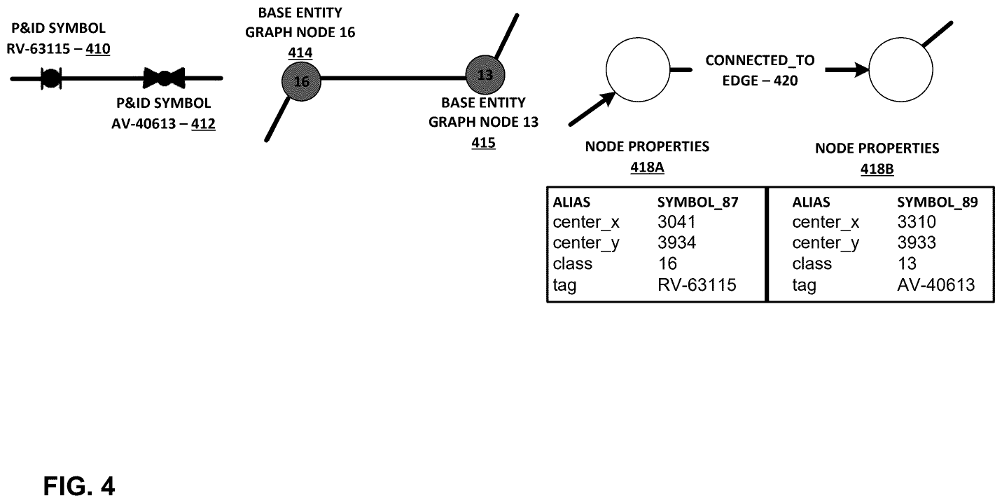

FIG. 4 illustrates an example mapping of P&ID symbols into corresponding graph-based entities within base entity graph nodes, in accordance with aspects of the disclosure. P&ID symbol RV-63115 410 and P&ID symbol AV-40613 412 represent instrument tags depicted within a P&ID sheet. During graph-based linking, base entity graph node 16 414 is assigned to P&ID symbol RV-63115 410 and base entity graph node 13 415 is assigned to P&ID symbol AV-40613 412. Base entity graph node 16 414 and base entity graph node 13 415 are connected by connected_to edge 420, which represents the relationship inferred between the symbols based on detected pipeline continuity. Node properties 418A associated with base entity graph node 16 414 include alias symbol_87, center_x coordinate 3041, center_y coordinate 3934, class value 16, and tag RV-63115. Node properties 418B associated with base entity graph node 13 415 include alias symbol_89, center_x coordinate 3310, center_y coordinate 3933, class value 13, and tag AV-40613. Connected_to edge 420 may also include semantic attributes, ensuring that both nodes and edges in base entity graph 320 are enriched when transformed into labeled property graph 324. As shown in FIG. 3B, node properties 322 extend this enrichment process, so that location information, aliases, class identifiers, and tags are captured as structured attributes accessible to query engines. This transformation of base entity graph node 16 414, base entity graph node 13 415, connected_to edge 420, node properties 418A, and node properties 418B exemplifies the second stage of the framework, where base entity graph 320 is converted into labeled property graph 324 enriched with semantic properties that enable retrieval via text-to-GQL module 328 and LLM module 332.

Node properties 418A and node properties 418B are respectively associated with base entity graph node 16 414 and base entity graph node 13 415. Node properties 418A and node properties 418B include attributes such as alias, location coordinates, class values, and tags as described above, ensuring that both nodes are semantically enriched within labeled property graph 324.

The transformation of base entity graph node 16 414, base entity graph node 13 415, connected_to edge 420, node properties 418A, and node properties 418B into a labeled property graph incorporates semantic enrichment beyond mere connectivity. Location information such as center_x and center_y, aliases, class identifiers, and tags are organized as structured attributes accessible to query engines. This enrichment is crucial for transforming base entity graph 320 into labeled property graph 324, which supports efficient information retrieval and downstream analysis.

In one example implementation, labeled property graph 324 is generated using Neo4j. Node properties such as tag values provide semantic leverage. For instance, in real-world P&ID documents, a line tag may encode multiple layers of information, such as a unit number, a line size in inches, a fluid type identifier (e.g., ATF representing aviation turbine fuel), a line number, and a material designation (e.g., CS representing carbon steel). These attributes can be captured within node properties 418A and node properties 418B, or associated with edges such as connected_to edge 420, enabling a richer information representation. Although synthetic datasets may lack such semantic encoding, real-world P&ID tags provide opportunities for embedding operationally significant metadata directly within the labeled property graph.

The process illustrated in FIG. 4 therefore exemplifies the second stage of the overall framework, in which base entity graph 320, composed of detected symbols, nodes, and edges, is transformed into a labeled property graph 324 enriched with semantic properties that extend its applications and enable retrieval via text-to-GQL module 328 and LLM module 332 (see FIG. 3).

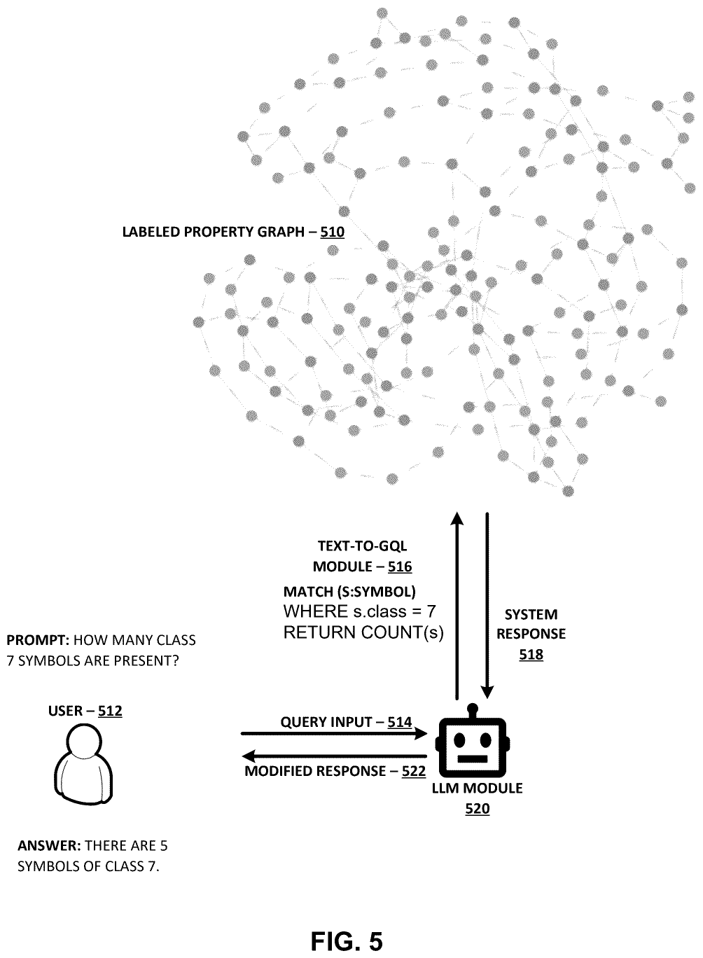

FIG. 5 illustrates an information retrieval system that interfaces a user with a labeled property graph, in accordance with aspects of the disclosure. Labeled property graph 510 represents the enriched graph database generated from prior processing steps and serves as the knowledge base for querying. User 512 provides query input 514, which may be expressed as a natural language prompt, such as a request to identify how many symbols of a particular class are present. Query input 514 is received by LLM module 520, which translates query input 514 into a structured graph query language representation.

Text-to-GQL module 516 processes query input 514 to generate an executable graph query, such as a Cypher statement. In one example, text-to-GQL module 516 generates a query of the form “MATCH (s:Symbol) WHERE s.class=7 RETURN COUNT(s),” enabling retrieval of symbol counts based on class values. Text-to-GQL module 516 transmits the generated query to labeled property graph 510, which executes the query against the stored semantic attributes of symbols and connections.

System response 518 includes the raw query result returned from labeled property graph 510. System response 518 is transmitted to LLM module 520, which interprets the structured result and reformats it into modified system response 522. Modified system response 522 is provided in a natural language form that user 512 can readily understand. For example, modified system response 522 may state, “There are 5 symbols of class 7.”

The process performed by labeled property graph 510, user 512, query input 514, text-to-GQL module 516, system response 518, LLM module 520, and modified system response 522 exemplifies the third stage of the overall framework. The knowledge graph enriched in earlier steps supports accurate and interpretable responses to user queries by leveraging LLM module 520 for translation and reformatting. A central challenge of this process is the ability of LLM module 520 to synthesize valid Cypher queries from free-form user prompts. Fine-tuning LLMs on P&ID-specific data could improve accuracy but is limited by the scarcity of high-quality training pairs linking natural language queries to Cypher outputs. Structural heterogeneity across P&ID graph schemas also constrains generalizability to unseen configurations.

To address these challenges, an instruction-tuning paradigm is applied, whereby LLM module 520 is dynamically conditioned on the target schema of labeled property graph 510 during inference. Supplementary metadata such as node and edge types, semantic meanings of attributes, and example query-response pairs may be incorporated into the context to guide LLM module 520 in generating domain-specific Cypher queries. Additionally, few-shot examples of natural language queries and their corresponding graph query language translations may be provided in-context to increase robustness to linguistic variations. To minimize randomness in outputs, the temperature parameter of LLM module 520 may be set to zero, producing deterministic responses.

Together, labeled property graph 510, user 512, query input 514, text-to-GQL module 516, system response 518, LLM module 520, and modified system response 522 demonstrate an end-to-end information retrieval system that translates free-form natural language queries into structured graph queries and returns accurate, human-readable answers.

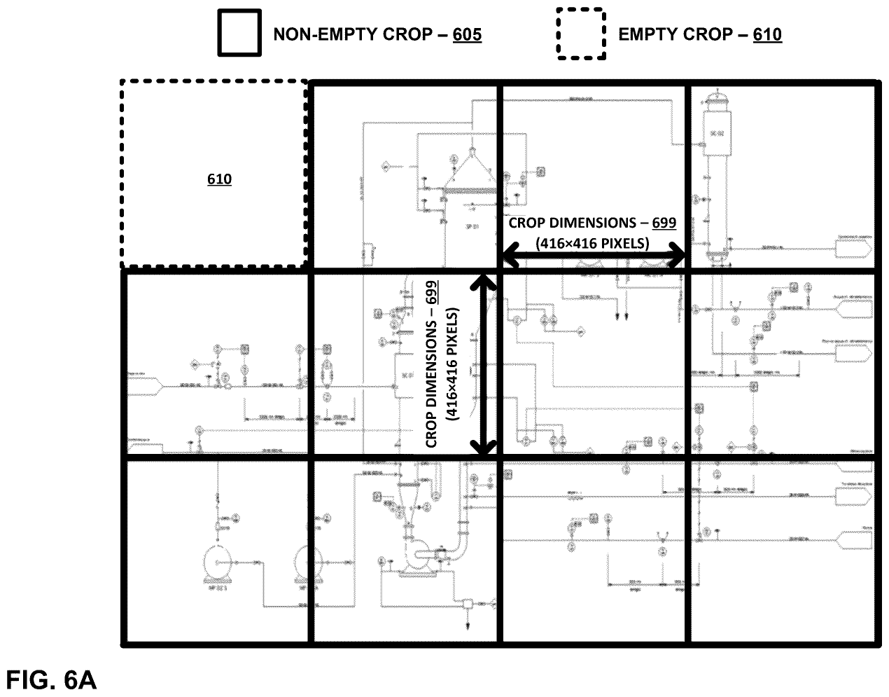

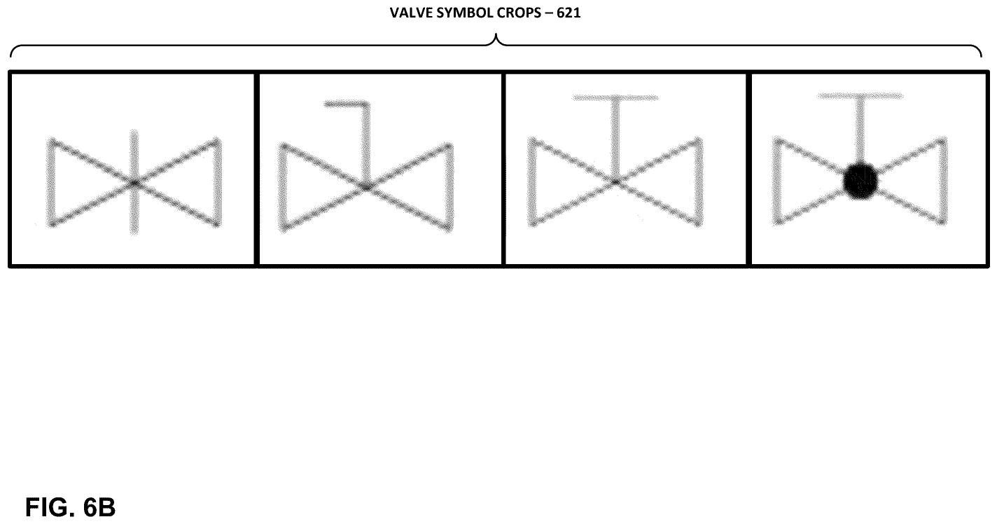

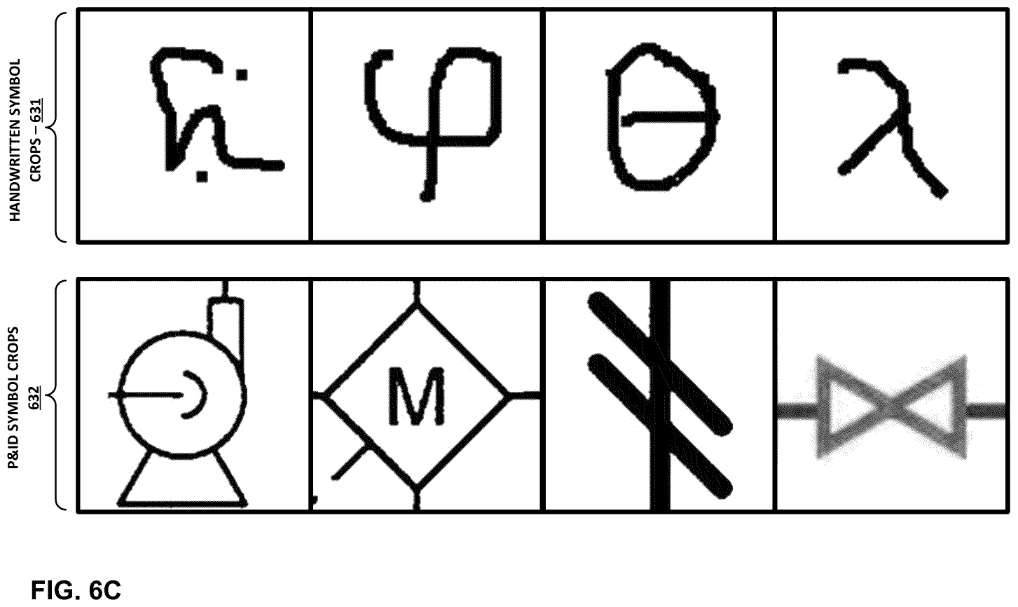

While FIGS. 3-5 illustrate the overall framework from P&ID inputs through graph transformation and natural language querying, FIGS. 6-9 focus on the underlying detection and representation techniques that enable the framework. These figures describe how P&ID sheets are preprocessed into crops, how visually ambiguous symbols are addressed, and how autoencoder-based architectures provide compact embeddings for robust symbol differentiation. Together, these detection and representation methods supply the foundational accuracy required for generating the graphs and supporting downstream query operations.

FIG. 6A illustrates example processing of a piping and instrumentation diagram (P&ID) sheet by dividing it into non-overlapping crops of uniform size 416×416 pixels, in accordance with aspects of the disclosure. For example, FIG. 6A includes crop dimensions 699 indicating the uniform crop size utilized throughout the preprocessing pipeline. The P&ID sheet is segmented into a 4×4 grid comprising 16 total crops.

Among the illustrated segments, non-empty crop 605 includes graphical and symbolic detail from the original P&ID sheet. In contrast, empty crop 610 contains no relevant P&ID content, representing regions devoid of useful symbols, text, or pipelines.

Data Preprocessing: The P&ID sheets in the dataset range in resolution from 1200×840 to 3500×2600 pixels, exceeding the input resolution suitable for many machine learning models. To allow efficient data processing and maintain context within each image, the P&ID sheets were divided into non-overlapping segments of crop dimensions 699. This crop size was selected as a compromise between memory requirements and the preservation of P&ID structural detail.

The preprocessing stage excluded empty crop 610 instances from training to improve data relevance. The final training dataset included 570 non-empty crop 605 instances, and the test dataset included 195 such crops.

FIG. 6B depicts valve symbol crops 621, which include an example of different but visually similar looking symbols in piping and instrumentation drawings detectable using symbol detection framework 170, in accordance with aspects of the disclosure. Valve symbol crops 621 illustrate symbols that may appear visually ambiguous to human annotators, thus presenting challenges for traditional labeling techniques.

Symbol detection framework 170 includes a two-stage semi-supervised framework for symbol detection and differentiation. In the first stage, symbol detection framework 170 applies a generic symbol detector using computer vision-based object detection. For this stage, all symbols on the piping and instrumentation drawings are labeled as a single class, which substantially reduces the labeling effort compared to approaches that require per-class annotation. Such a reduction minimizes the time-consuming and confusion-inducing complexity for a human annotator to manually label a large number of classes, particularly when the symbols have similar appearances, as shown in valve symbol crops 621.

Labeling all symbols as a single class can reduce the need for manual interaction and reduce the computational resources and overall cost of data annotation. This method of labeling is related to the symbol differentiation strategy using self-supervised learning in a second stage of symbol detection framework 170. Additionally, training the model on a dataset where all classes are labeled as one single class can improve robustness of the model by encouraging the model to learn general features that are shared across all symbol types.

The first stage of symbol detection framework 170 also examines various aspects of machine learning model development for symbol recognition in piping and instrumentation drawings, including: (1) training and model performance speed measured in mAP for training from scratch versus transfer learning; (2) the relationship between annotation volume and model performance; (3) the effect of sampling techniques on model performance, including simple random sampling and k-means coreset sampling; and (4) the applicability of pseudo-labels to expand training data without additional human annotations.

A deep neural network model, Yolo version 4 (Yolo-v4), is used to localize symbols in piping and instrumentation drawings. Yolo is selected for its accuracy, inference speed, and compatibility with multiple frameworks such as TensorFlow, PyTorch, and Darknet. Models can be trained from scratch or using transfer learning. Training from scratch involves constructing a model architecture and tuning hyperparameters to achieve acceptable performance thresholds. Transfer learning, in contrast, starts from a pretrained model and adapts it to the task by updating model weights using the target dataset. Pretrained models, typically trained on large datasets, provide a strong initialization that can accelerate convergence and improve final performance.

Training from scratch may be beneficial when the target task is unrelated to existing domains or when substantial labeled data is available. Transfer learning may be advantageous when labeled data is limited or when the target domain shares characteristics with existing large-scale datasets. In this context, both training from scratch and transfer learning approaches are explored. Training from scratch is considered due to the lack of pretrained models for technical symbol domains, whereas transfer learning enables initialization from models trained on public datasets. Transfer learning experiments include three pretrained networks: one trained for object detection on MS COCO and two trained for image classification on ImageNet and Omniglot. MS COCO and ImageNet contain natural images, while Omniglot includes handwritten characters from over 50 languages. Omniglot is hypothesized to accelerate training due to its visual similarity to technical symbols such as those shown in valve symbol crops 621.

FIG. 6C illustrates handwritten symbol crops 631 and P&ID symbol crops 632. Handwritten symbol crops 631 correspond to symbols derived from an Omniglot dataset, which includes handwritten characters from a variety of alphabets, in accordance with aspects of the disclosure. These symbols are used to simulate visual characteristics such as stroke style, curvature, and thickness found in non-standardized or manually created glyphs. Omniglot symbols represented in handwritten symbol crops 631 may resemble phonetic or linguistic forms intended for phoneme representation in language transcription, such as vowels, consonants, and phonetic modifications like aspiration or nasalization. These symbols introduce variation in appearance that may be visually similar to engineering symbols in P&ID sheets, creating challenges for conventional object detection models and motivating more robust symbol differentiation techniques.

P&ID symbol crops 632 include symbol instances extracted from piping and instrumentation drawings. P&ID symbol crops 632 depict standardized technical symbols used to denote specific engineering components such as mechanical actuators, flow elements, process equipment, or instrumentation nodes. These images may be used to train or evaluate a symbol detection model to distinguish among complex graphical elements under varying resolutions, line thickness, or partial occlusion. Both handwritten symbol crops 631 and P&ID symbol crops 632 include foreground linework rendered in black or grayscale, with white backgrounds, consistent with common preprocessed input to detection models.

To evaluate performance of symbol detection framework 170 under varying dataset conditions, four object detection models based on Yolo were trained using images from handwritten symbol crops 631 and P&ID symbol crops 632. Each model was trained for 4,500 iterations using 90% of the available dataset (513 crops) for training and 10% (57 crops) for validation. This evaluation provided a baseline comparison across different Yolo-based implementations while demonstrating how symbol detection framework 170 may leverage both handwritten and technical symbol datasets to improve generalization.

To assess the impact of annotation effort on detection performance, additional experiments were conducted by varying the proportion of labeled training data across a range of values: 5%, 10%, 15%, 20%, 30%, 40%, 50%, 60%, 70%, 80%, 90%, and 100%. For each percentage level, data points were sampled randomly, and resulting models were evaluated on a fixed test dataset. This analysis demonstrates how symbol detection framework 170 balances annotation cost against detection accuracy, enabling efficient trade-off decisions during deployment.

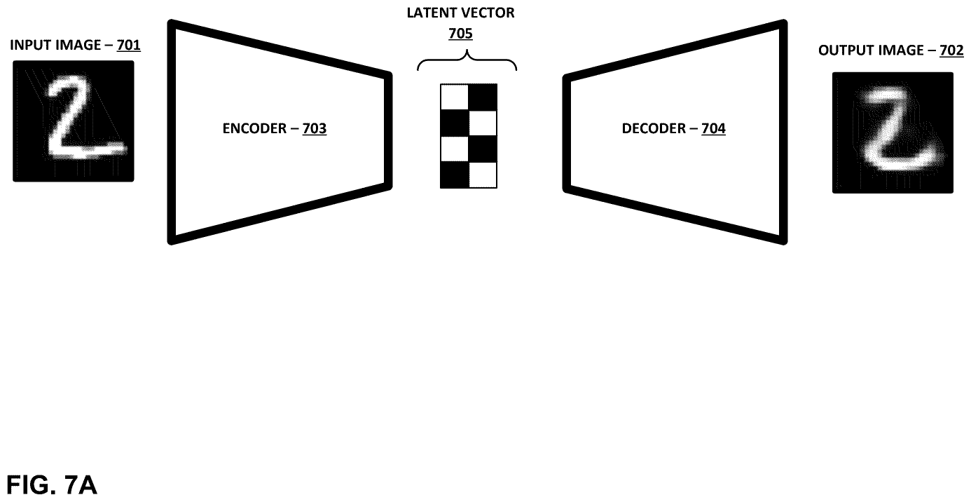

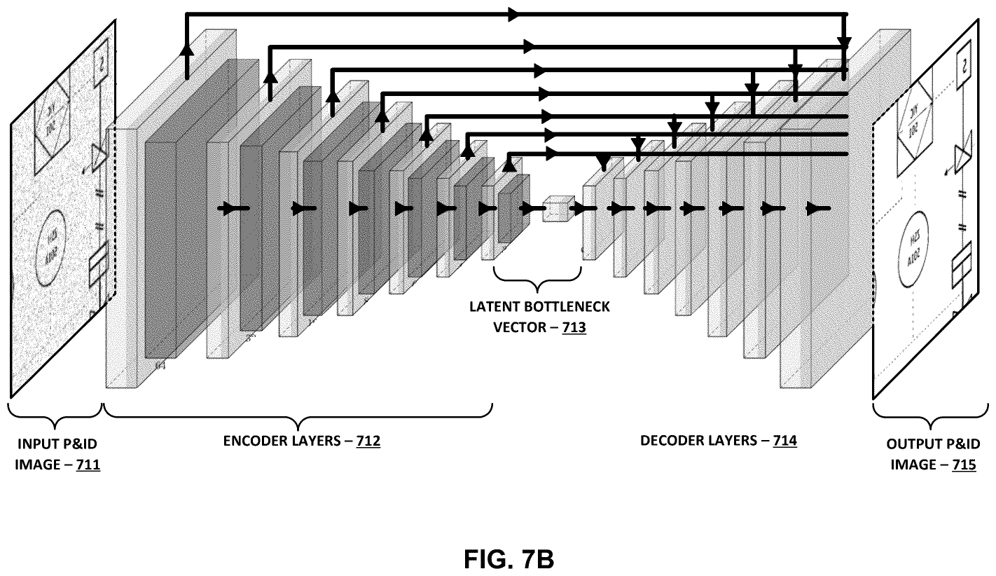

FIG. 7A illustrates an example representation of a typical autoencoder architecture used by symbol detection framework 170, in accordance with aspects of the disclosure. Input image 701 includes a digital symbol representation, such as a handwritten or P&ID symbol image, fed into encoder 703. Encoder 703 processes input image 701 through a deep neural network that compresses the high-dimensional input into a lower-dimensional latent representation. Encoder 703 outputs latent vector 705, which represents a bottleneck embedding that captures the most salient semantic and structural characteristics of input image 701.

Latent vector 705 includes compressed features that form the basis for reconstruction. Decoder 704 receives latent vector 705 and reconstructs output image 702, which closely approximates input image 701 in pixel-space. The model comprising encoder 703, latent vector 705, and decoder 704 is trained end-to-end using backpropagation to minimize the reconstruction error between input image 701 and output image 702. Autoencoders of this kind are useful for feature compression, denoising, and symbolic differentiation, especially in complex visual domains like P&ID diagram interpretation.

Symbol detection framework 170 utilizes this autoencoder structure to generate reduced-dimensionality embeddings from symbol image data, enabling efficient sampling and scalable training. Each symbol image in the dataset includes 519,168 pixel values (416×416×3). With a dataset of 570 images, operating on raw pixel data would require the processing of over 295 million individual pixel values. Storing and manipulating this scale of data is computationally inefficient, particularly in resource-constrained environments or real-time inference pipelines. Autoencoders provide an effective mechanism to circumvent this limitation by transforming symbol images into compressed latent representations, such as latent vector 705.

Symbol detection framework 170 may apply different sampling strategies to evaluate model performance and improve training efficiency. In particular, random sampling and K-means coreset sampling are employed to select representative subsets of training data for model development. Random sampling provides unbiased data selection but may fail to preserve the global structure of the data distribution. In contrast, the K-means coreset sampling method provides a principled approach for subset selection by first identifying clusters within the latent space and then selecting a representative weighted subset that approximates the full dataset's clustering structure.

The K-means coreset sampling method is designed to approximate the K-means clustering objective while operating on a reduced subset of data. Symbol detection framework 170 computes latent vector 705 for each input image 701 using encoder 703 and then applies K-means clustering within the latent space. The method selects a weighted coreset of latent vectors that mirror the full distribution, maintaining important properties such as intra-cluster compactness and inter-cluster separation. Each selected latent vector 705 in the coreset is assigned a weight to reflect its importance in approximating the full objective function.

By using coreset-based selection, symbol detection framework 170 can significantly reduce training overhead while preserving performance. This coreset-based sampling also provides an approximation guarantee, meaning that a model trained on the coreset will achieve accuracy close to that obtained with the full dataset. This allows stakeholders to evaluate the tradeoffs between annotation cost and model performance, enabling more informed resource allocation decisions.

In addition, symbol detection framework 170 benefits from the structural properties of the learned latent space, where latent vector 705 encodes features such as line thickness, symbol orientation, character stroke patterns, and edge density. These properties make the latent space suitable for both clustering and unsupervised representation learning. Encoder 703 and decoder 704, as depicted in FIG. 7A, together enable dimensionality reduction, reconstruction, and embedding for downstream applications including classification, search, symbol retrieval, or symbol disambiguation.

Autoencoder architectures like that illustrated in FIG. 7A are particularly beneficial for use in noisy or low-resolution environments, and serve as a foundational element for symbol detection framework 170 in both training and inference stages.

FIG. 7B illustrates a denoising autoencoder architecture for processing engineering diagrams, such as piping and instrumentation diagrams, used within symbol detection framework 170, in accordance with aspects of the disclosure. Input P&ID image 711 includes a corrupted or noise-perturbed instance of a diagrammatic sheet. Input P&ID image 711 is structured as a three-channel color image with dimensions 416×416×3. Noise may be added to input P&ID image 711 through Gaussian perturbation, occlusion, blurring, or other stochastic degradation techniques. The denoising objective of the model is to reconstruct a clean and accurate version of the original image from this corrupted input.

In the example of FIG. 7B, the denoising autoencoder is depicted schematically, where noise is conceptually applied to input P&ID image 711, and subsequent encoder layers 712 operate to extract robust features despite such perturbations.

Encoder layers 712 receive input P&ID image 711 and perform a series of nonlinear transformations including convolutional filtering, spatial downsampling, and activation operations. These layers extract hierarchical spatial features from input P&ID image 711 while compressing the dimensionality of the image representation. Encoder layers 712 progressively reduce the spatial resolution and increase the feature depth, resulting in a highly compact feature encoding. The final layer in encoder layers 712 outputs latent bottleneck vector 713, which serves as a dense embedding of the input symbol layout. Latent bottleneck vector 713 is a 12-dimensional vector with spatial shape 2×2×3, representing a compressed abstraction of input P&ID image 711 that encodes semantic structure, geometric patterns, and symbol presence.

Decoder layers 714 receive latent bottleneck vector 713 and reconstruct output P&ID image 715 through a sequence of upsampling, transposed convolution, and activation operations. Decoder layers 714 mirror encoder layers 712 in structure but operate in reverse, expanding the latent space back into full-resolution image dimensions. Output P&ID image 715 is generated with the same shape as input P&ID image 711 and is optimized to approximate a clean, de-noised version of the original diagram. Skip connections, as shown in FIG. 7B, directly connect encoder layers 712 to decoder layers 714 at corresponding levels. These connections provide high-resolution spatial information to decoder layers 714, improving image fidelity and accelerating convergence.

The compressed representations derived from latent bottleneck vector 713 are used as input for symbolic feature analysis, coreset sampling, or unsupervised clustering. Specifically, latent bottleneck vector 713 forms a compact feature embedding used to compare image instances across a dataset, enabling K-means coreset sampling. These 12-dimensional representations preserve relevant structural signals while eliminating background noise, allowing symbol detection framework 170 to learn efficient symbolic relationships and diagram-wide patterns.

To expand the size of the training dataset without requiring additional manual annotations, symbol detection framework 170 applies a pseudo-labeling strategy. A model pretrained on labeled P&ID data is used to infer labels for unlabeled samples. These inferred labels, referred to as pseudo-labels, are treated as ground truth during subsequent training iterations. Pseudo-labeling allows symbol detection framework 170 to bootstrap from limited labeled data and scale model performance using large pools of unlabeled diagrams. Pseudo-labeled data are added in incremental batches, such as 10% of the dataset at a time, to prevent overfitting and preserve training stability.

To prevent confirmation bias during pseudo-label generation, the pseudo-labeling model is selected based on high mean average precision (mAP) performance on a held-out validation set. Data augmentation techniques such as rotation, scaling, jittering, or contrast normalization may be applied to both labeled and unlabeled inputs to improve generalization. Output P&ID image 715 produced by decoder layers 714 is used to validate that the latent bottleneck vector 713 preserves sufficient semantic information for effective denoising and reconstruction.

The architecture depicted in FIG. 7B enables symbol detection framework 170 to clean, compress, and structurally represent engineering drawings for use in symbolic learning, retrieval, and classification pipelines.

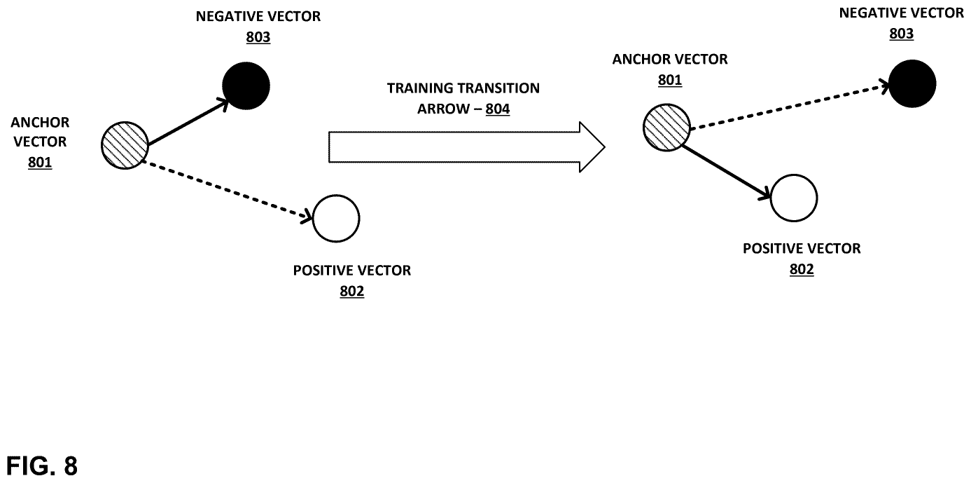

FIG. 8 illustrates a vector space representation of a triplet loss learning process used during training of a Siamese network configured for symbol differentiation, in accordance with aspects of the disclosure. As shown, anchor vector 801, positive vector 802, and negative vector 803 are used to construct a triplet input for the network. Anchor vector 801 represents a vector embedding generated from an anchor image. Positive vector 802 represents a vector embedding of a positive image belonging to the same symbol class as the anchor image. Negative vector 803 represents a vector embedding of a negative image belonging to a different symbol class than the anchor image. On the left side of FIG. 8, anchor vector 801 is initially positioned closer to negative vector 803 than to positive vector 802, illustrating the challenge that the triplet loss learning process is designed to overcome.

Symbol detection framework 170 applies a Siamese network architecture that includes multiple subnetworks operating in parallel, such that anchor vector 801, positive vector 802, and negative vector 803 are computed simultaneously. Each subnetwork processes one of the images in the triplet and outputs a corresponding vector embedding. The subnetworks are configured to share identical weights to enforce consistent transformation across all triplet inputs.

During training, symbol detection framework 170 applies a triplet loss function that operates on anchor vector 801, positive vector 802, and negative vector 803. The triplet loss function is configured to minimize the Euclidean distance between anchor vector 801 and positive vector 802 while simultaneously maximizing the Euclidean distance between anchor vector 801 and negative vector 803. This objective encourages the network to learn an embedding space in which symbols of the same class are clustered closely together, while symbols of different classes are separated.

Training transition arrow 804 represents the optimization process in which network parameters are updated through gradient-based learning to enforce the triplet loss objective. During training, anchor vector 801 and positive vector 802 are iteratively moved closer together in the embedding space, while anchor vector 801 and negative vector 803 are pushed farther apart. After application of training transition arrow 804, the adjusted positions of anchor vector 801, positive vector 802, and negative vector 803 reflect the similarity and dissimilarity relationships learned by the network.

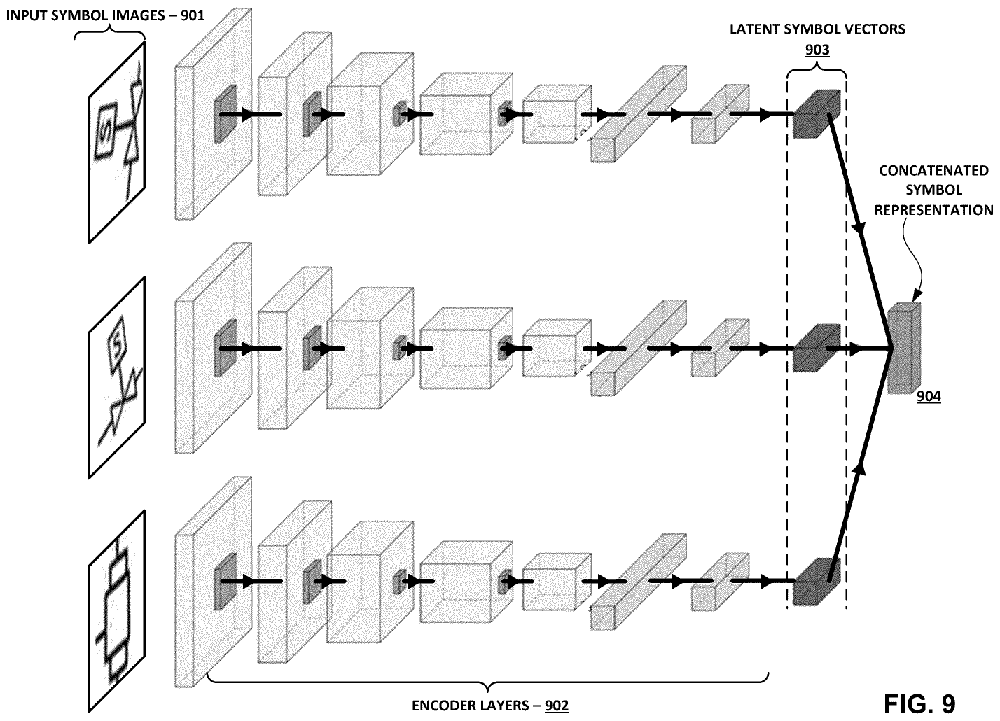

FIG. 9 illustrates an example architecture of a Siamese network utilized by symbol detection framework 170, in accordance with aspects of the disclosure. Input symbol images 901 include multiple symbol samples used to construct training triplets, such as anchor images, positive images, and negative images. Each image in input symbol images 901 is individually processed through identical encoder layers 902 to generate corresponding latent symbol vectors 903.

Encoder layers 902 are configured to standardize each input symbol image to a spatial resolution of 224×224×3 pixels and progressively extract abstract features via convolutional or similar operations. The output of encoder layers 902 is a 256-dimensional latent symbol vector for each respective input.

In an implementation, the encoder layers 902 are shared across the three processing branches of the Siamese network to ensure consistent feature extraction across anchor, positive, and negative inputs. Symbol detection framework 170 generates latent symbol vectors 903 for each input symbol image of a triplet, using identical transformation weights.

Concatenated symbol representation 904 is generated by combining the latent symbol vectors 903. The concatenated symbol representation 904 may be used as an intermediate structure for applying the triplet loss function or for additional post-processing tasks, such as computing pairwise distances between vector embeddings.

FIG. 9 illustrates the encoding and concatenation process, where input symbol images 901 are transformed into latent symbol vectors 903 through encoder layers 902 and combined into concatenated symbol representation 904. In the broader training procedure, positive images may be programmatically generated from anchor images by applying geometric transformations such as cropping, scaling, or rotating, while negative images are sampled from symbols belonging to different classes. These additional steps are applied outside the schematic of FIG. 9 to construct training triplets.

Using this procedure, a total of 10,000 triplets are constructed from the training dataset in a self-supervised manner. Each triplet includes one anchor image, one corresponding positive image, and one negative image. The Siamese network is trained using a triplet loss function applied to the concatenated symbol representation 904 to enforce class-specific separability within the embedding space.

The triplet loss function minimizes the Euclidean distance between the latent symbol vectors 903 corresponding to the anchor and positive images, while maximizing the Euclidean distance between the anchor and negative vectors. This training strategy promotes a representation space in which embeddings of similar symbols are clustered and embeddings of dissimilar symbols are separated.

To evaluate performance, a test database including 538 symbol instances across 102 unique symbol classes is assembled. The test database is constructed from 20 piping and instrumentation diagram (P&ID) sheets within the evaluation dataset.

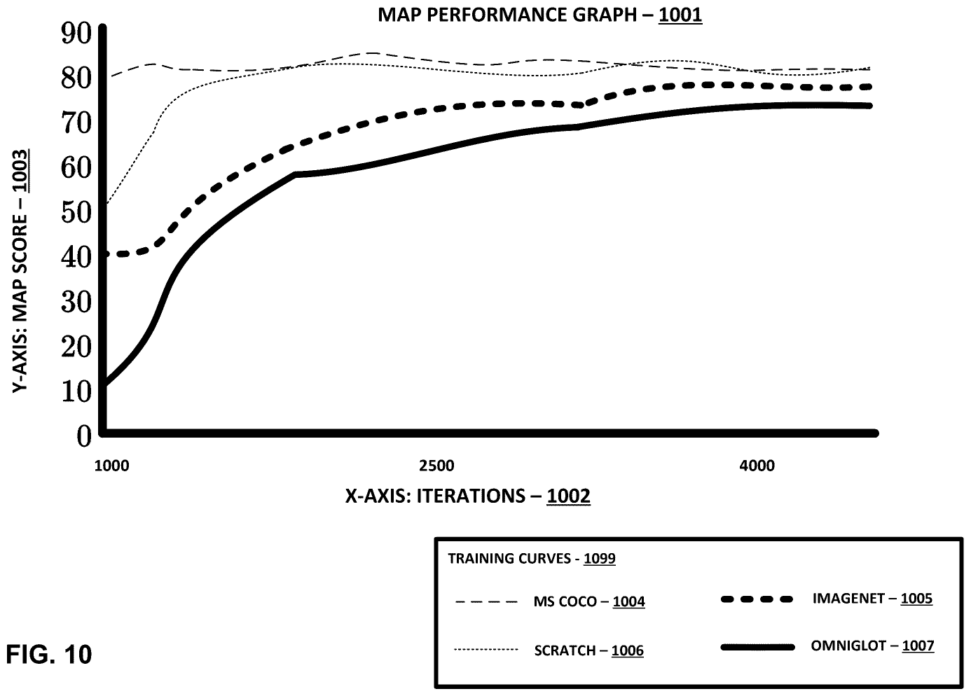

FIG. 10 illustrates mAP performance graph 1001 showing the comparative training performance of different model initialization strategies used in symbol detection framework 170. X-axis iterations 1002 represent training progress in number of iterations, and y-axis mAP score 1003 represents the mean average precision (mAP) score achieved by the model. Training curves 1099 include results for MS Coco 1004 (dashed line), Imagenet 1005 (bold dashed line), Scratch 1006 (dotted line), and Omniglot 1007 (bold solid line).

The model initialized using MS Coco 1004 transfer learning weights achieved the highest mAP score of about 84.8% with the fastest convergence. The rapid rise and plateau of MS Coco 1004 demonstrate strong task alignment, as both MS Coco 1004 and the P&ID symbol detection task involve object detection. This initialization not only provided the highest accuracy but also reduced training time compared to other strategies.

The model trained from scratch, shown by Scratch 1006 (dotted line), achieved a final mAP score of about 82.8%. While close in accuracy to MS Coco 1004, Scratch 1006 required substantially more iterations to converge, illustrating that scratch training can be effective but at the cost of computational efficiency.

Imagenet 1005 (bold dashed line) and Omniglot 1007 (bold solid line) exhibited lower performance. Imagenet 1005 peaked at about 77.4% and Omniglot 1007 at about 73.4%. Their reduced effectiveness is attributed to task misalignment: Imagenet 1005 and Omniglot 1007 are trained for image classification tasks, while the P&ID task requires object detection. In addition, Omniglot 1007 was trained on binarized handwriting data, whereas the P&ID dataset uses RGB technical diagrams, introducing a modality mismatch that further degraded performance.

As depicted, mAP performance graph 1001 emphasizes the benefits of task-aligned transfer learning, while showing that scratch training can still reach near-equivalent results given sufficient iterations, albeit with higher computational cost.

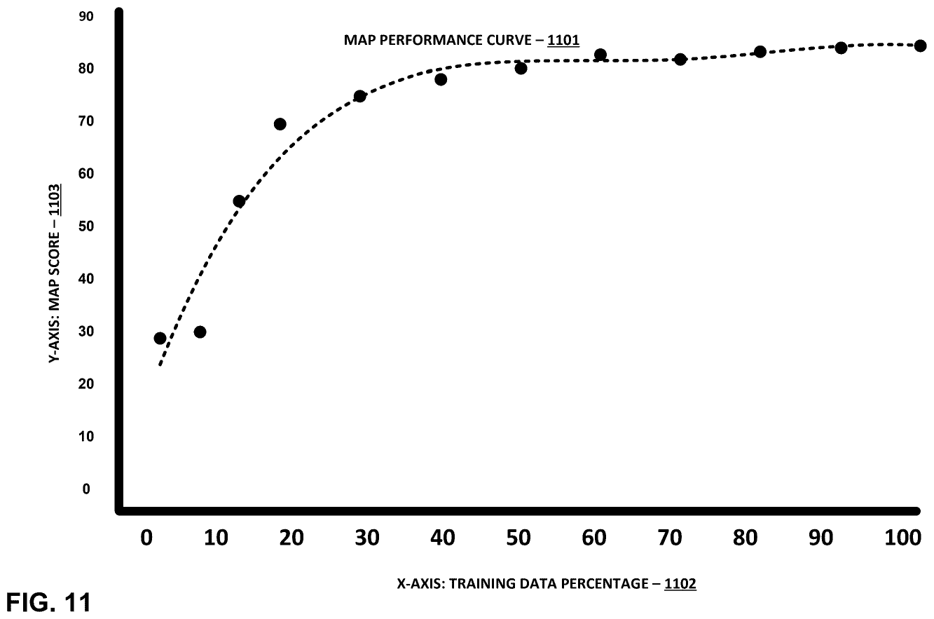

FIG. 11 illustrates mAP performance curve 1101 plotted over x-axis training data percentage 1102 and y-axis mAP score 1103, in accordance with aspects of the disclosure. As depicted, mAP performance curve 1101 builds upon the insights of mAP performance graph 1001 in FIG. 10 by showing how symbol detection performance, measured by mean average precision (mAP), depends not only on initialization strategy but also on the proportion of annotated training data.

As depicted, mAP performance curve 1101 begins with an mAP score of approximately 30.47% when trained using 5% of the available annotated dataset. As training data volume increases, the performance improves, reaching a maximum mAP score of approximately 83.98% when trained using 100% of the available data. However, mAP performance curve 1101 demonstrates that this improvement is not linear.

Between 5% and 20% on x-axis training data percentage 1102, mAP performance curve 1101 shows a steep incline in y-axis mAP score 1103, with mAP improving from 30.47% to approximately 70%. Beyond 60% on x-axis training data percentage 1102, the curve begins to plateau, indicating diminishing returns from additional annotated data. From 60% to 100%, the mAP increases by only about 2 percentage points.

The shape of mAP performance curve 1101 indicates that symbol detection framework 170 can achieve most of its learning benefit using a relatively small portion of annotated training data. This observation aligns with the properties of piping and instrumentation diagram (P&ID) datasets, where symbols exhibit strong structural regularity and low intra-class variability. Accordingly, early training enables effective feature learning, and performance saturates quickly with respect to data volume.

This finding has implications for resource-constrained annotation strategies. When deploying symbol detection framework 170, an organization may elect to cap manual labeling once performance enters the saturation zone shown in mAP performance curve 1101. Instead, resources may be shifted toward architectural refinement, augmentation policies, or transfer learning, as highlighted in FIG. 10, to achieve further gains without increasing labeled data volume.

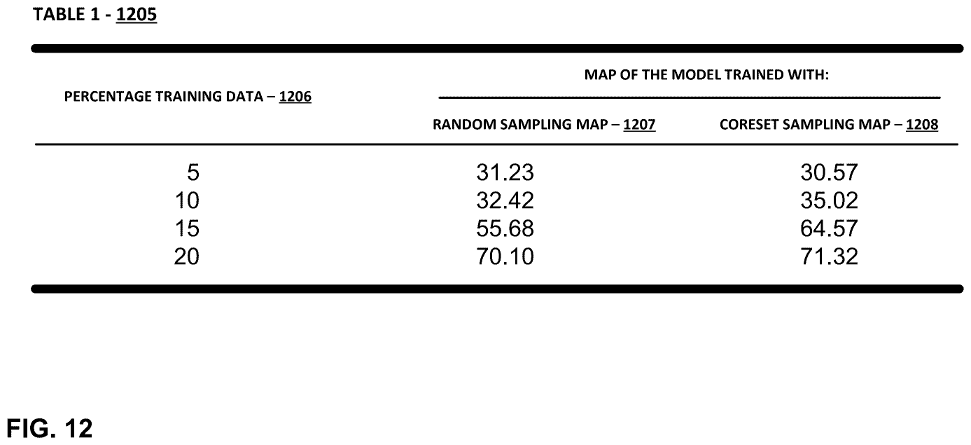

FIG. 12 illustrates table 1 1205 showing the impact of sampling strategy on model performance when trained on limited subsets of annotated data, in accordance with aspects of the disclosure. Table 1 1205 compares mAP scores under two sampling methods, random sampling mAP 1207 and coreset sampling mAP 1208, at different levels of percentage training data 1206.

Percentage training data 1206 includes values of 5, 10, 15, and 20 percent. At each of these levels, mAP scores are reported for both random sampling mAP 1207 and coreset sampling mAP 1208. For example, at 5 percent of percentage training data 1206, random sampling mAP 1207 yields a score of 31.23, while coreset sampling mAP 1208 yields 30.57. At 20 percent of percentage training data 1206, random sampling mAP 1207 yields 70.10, whereas coreset sampling mAP 1208 achieves 71.32.

Symbol detection framework 170 applies K-means coreset sampling after training a denoising autoencoder to select informative subsets from the dataset. These subsets are selected to minimize redundancy and maximize representational diversity. Table 1 1205 demonstrates that as the amount of training data increases, coreset sampling mAP 1208 outperforms random sampling mAP 1207 by increasingly larger margins. While performance at 5 percent is nearly identical, the advantage of coreset sampling mAP 1208 becomes more pronounced at higher levels of percentage training data 1206.

These results indicate that coreset sampling using learned representations offers a more data-efficient strategy for model training, especially when annotations are costly or limited. Symbol detection framework 170 may, in some implementations, restrict analysis to only 20 percent of percentage training data 1206 while still achieving strong model performance. As with the saturation pattern observed in mAP performance curve 1101 of FIG. 11 and the initialization trends in mAP performance graph 1001 of FIG. 10, further expansion of training data is expected to result in diminishing returns. Thus, table 1 1205 supports use of K-means coreset sampling mAP 1208 as a practical method for optimizing annotation efficiency without compromising model accuracy.

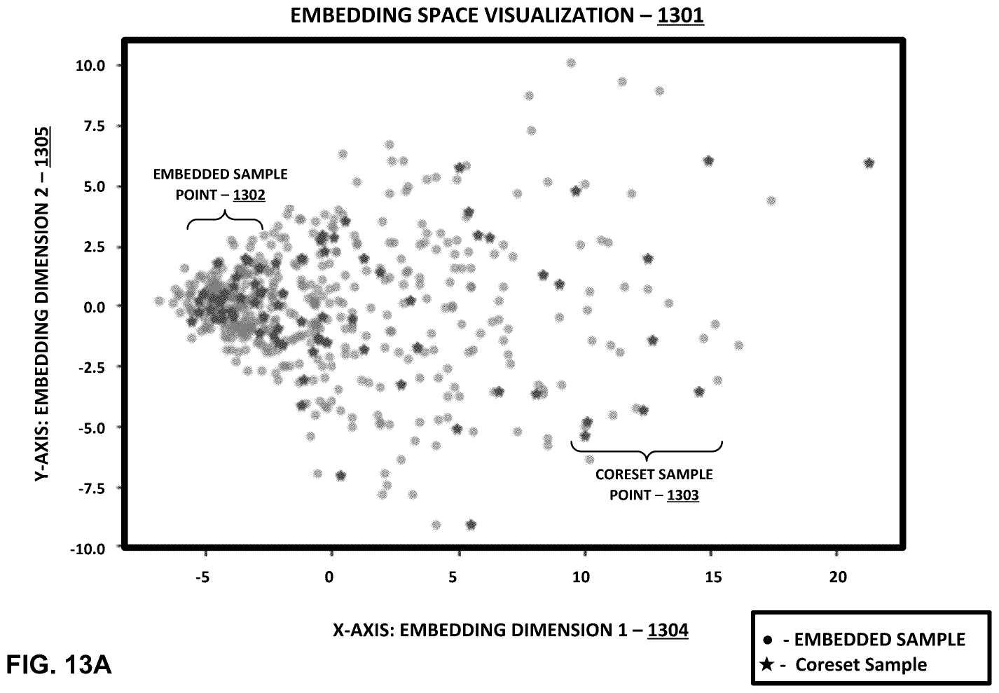

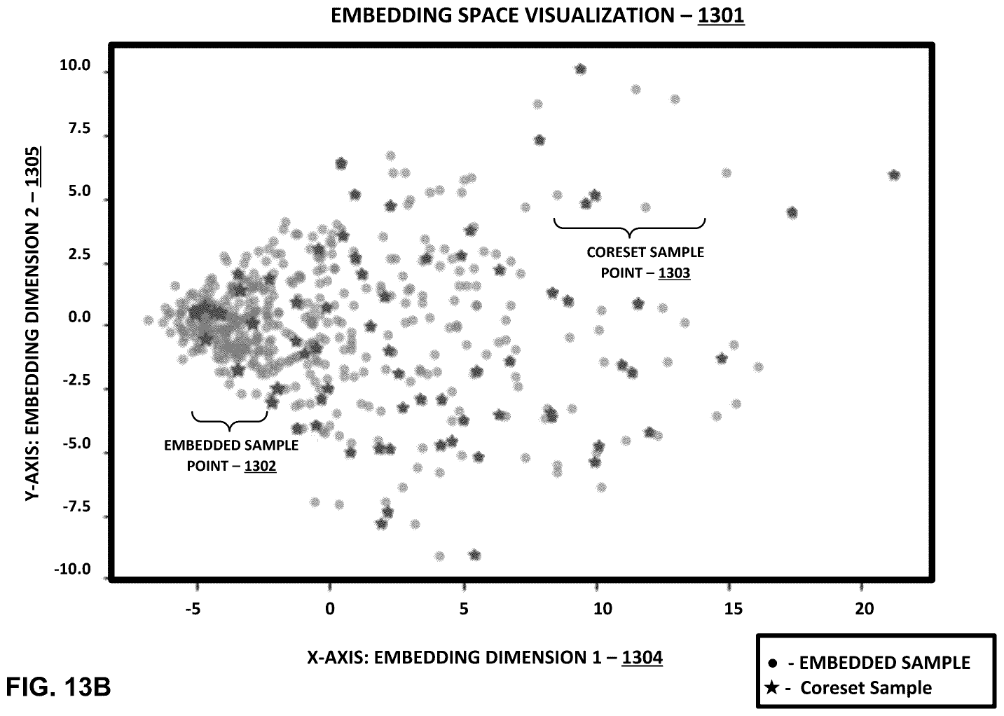

FIG. 13A and FIG. 13B illustrate embedding space visualization 1301, which plots embedded sample point 1302 and coreset sample point 1303 across x-axis embedding dimension 1 1304 and y-axis embedding dimension 2 1305, in accordance with aspects of the disclosure. Each visualization provides a two-dimensional projection of the latent feature space, generated by applying principal component analysis (PCA) to high-dimensional embeddings produced by symbol detection framework 170.

In FIG. 13A, embedded sample point 1302 represents a randomly selected 15 percent subset of the full dataset. These points are visualized as darker circular markers overlaid against lighter circular markers representing the complete dataset. The distribution of embedded sample point 1302 reveals visible clustering and redundancy, with many selected samples concentrated in dense central regions of the latent space defined by x-axis embedding dimension 1 1304 and y-axis embedding dimension 2 1305. As a result, significant portions of the embedding space, particularly peripheral regions, remain underrepresented by this random sampling strategy.

By contrast, FIG. 13B illustrates coreset sample point 1303, which also represents 15 percent of the dataset but is selected using K-means coreset sampling. Coreset sample point 1303 is depicted as star-shaped markers that are more evenly distributed across embedding space visualization 1301. Unlike the random subset shown in FIG. 13A, coreset sample point 1303 provides coverage not only of the dense central clusters but also of peripheral and outlying regions of the latent space. This broader spatial coverage reflects improved representational diversity and demonstrates how coreset sampling minimizes redundancy while preserving key variations in the dataset.

Symbol detection framework 170 leverages this coreset sampling approach to ensure that training subsets capture the full variability of the dataset, even when only a fraction of the data is annotated. In practice, this enables the framework to achieve higher performance at a lower annotation cost, as the selected coreset provides a more informative training signal compared to a randomly drawn subset of the same size.

Accordingly, FIG. 13A and FIG. 13B together illustrate that principled sampling strategies, such as K-means coreset selection, provide superior data efficiency relative to uniform random sampling. While embedded sample point 1302 highlights the redundancy and inefficiency of unoptimized subsets, coreset sample point 1303 shows that carefully chosen samples can improve both learning quality and downstream detection accuracy without requiring an increase in the overall annotation budget.

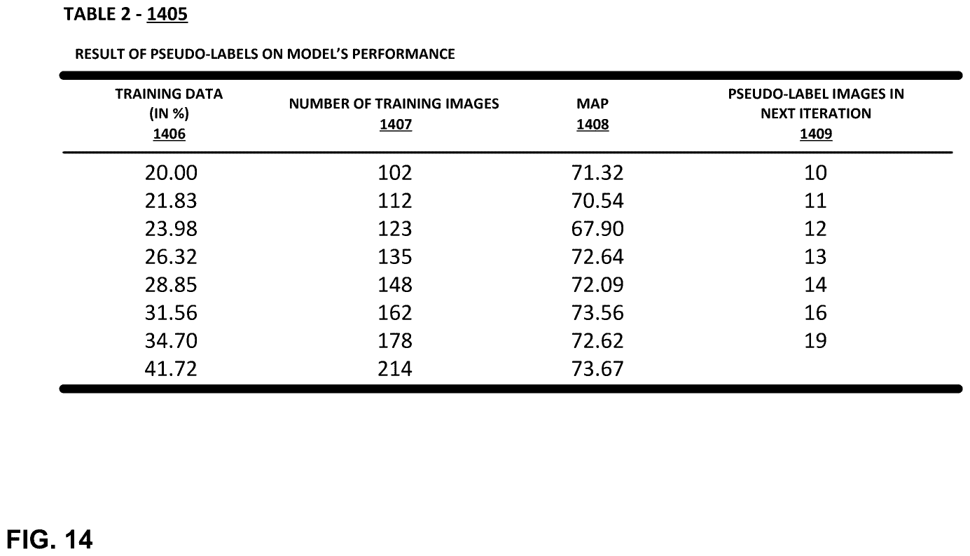

FIG. 14 illustrates table 2 1405, which summarizes the impact of pseudo-label images in next iteration 1409 on model performance, in accordance with aspects of the disclosure. Table 2 1405 includes four columns: training data (in %) 1406, number of training images 1407, mAP 1408, and pseudo-label images in next iteration 1409.

Training data (in %) 1406 begins at 20.00 percent and increases incrementally to 41.72 percent. Correspondingly, the number of training images 1407 ranges from 102 to 214 across iterations. At the baseline, when symbol detection framework 170 was trained on 20.00 percent of training data (in %) 1406, the model achieved a mAP 1408 of 71.32 using 102 manually annotated training images. This configuration served as the initialization point for iterative pseudo-labeling, consistent with the pseudo-labeling strategy described with respect to FIG. 7B.

In subsequent iterations, symbol detection framework 170 expanded the training dataset by introducing pseudo-label images in next iteration 1409. For example, in the first expansion step, 10 pseudo-label images in next iteration 1409 were added, bringing the total number of training images 1407 to 112. Despite the addition, mAP 1408 decreased slightly to 70.54, reflecting a temporary fluctuation often observed when pseudo-label noise is introduced. With further iterations, the dataset continued to grow: at 23.98 percent training data (in %) 1406, 123 total images yielded a mAP 1408 of 67.90, while at 26.32 percent training data (in %) 1406, 135 images produced a mAP 1408 of 72.64. This iterative process continued through multiple expansion cycles, with pseudo-label images in next iteration 1409 increasing incrementally from 10 to 19 across rows of table 2 1405.

By the final recorded iteration, the dataset had expanded to 214 images, consisting of 102 manually annotated images supplemented by 112 pseudo-label images in next iteration 1409. At this stage, the model achieved a mAP 1408 of 73.67, representing a net performance improvement relative to the baseline.

These results demonstrate that iterative pseudo-labeling enables dataset growth and improved detection performance without requiring additional manual annotations. While local fluctuations in mAP 1408 occur due to the inclusion of imperfect pseudo-labels, the overall performance trend is upward, with the model converging toward higher accuracy as more pseudo-labels are introduced.

As discussed in FIG. 7B, the denoising autoencoder first provides robust latent embeddings for symbol layouts, which helps stabilize pseudo-label inference. FIG. 14 shows how this mechanism is operationalized in practice: pseudo-labels expand the dataset in controlled increments, ensuring stable training and preventing overfitting while maintaining annotation efficiency. Together, the denoising and pseudo-labeling stages allow symbol detection framework 170 to bootstrap larger and more effective training sets with minimal human supervision.

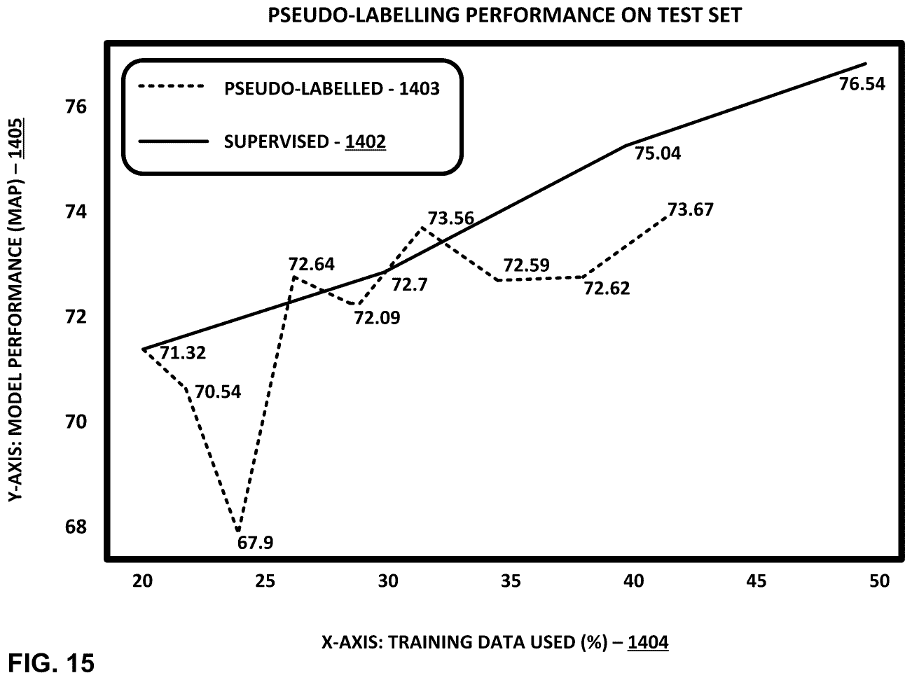

FIG. 15 illustrates pseudo-labelling performance on a test set, plotted over x-axis training data used (%) 1404 and y-axis model performance (mAP) 1405, in accordance with aspects of the disclosure. The graph compares two learning scenarios: supervised 1402 and pseudo-labelled 1403. Both curves capture model performance as a function of increasing training data volume.

Supervised 1402, represented by the solid line, reflects a baseline condition where symbol detection framework 170 is trained exclusively on manually annotated data. This curve shows a steady, approximately linear increase in performance, beginning at 71.32 mAP at 20 percent training data and reaching 76.54 at 50 percent training data. The supervised baseline provides a reference for maximum achievable accuracy when annotation cost is not a limiting factor.

Pseudo-labelled 1403, represented by the dashed line, reflects a semi-supervised condition where symbol detection framework 170 is trained on a combination of manually annotated data and pseudo-label images generated iteratively. At 20 percent training data, pseudo-labelled 1403 also begins at 71.32 mAP. However, early iterations show volatility, with the curve dipping to 70.54 and then 67.90 as noisy pseudo-labels temporarily degrade performance. This mirrors the fluctuations observed in table 2 of FIG. 14, where incremental pseudo-label additions initially reduced mAP before stabilizing.

As training data usage increases, pseudo-labelled 1403 recovers and surpasses its early baseline, achieving 72.64 at 26.32 percent, 73.56 at 31.56 percent, and ultimately 73.67 at 41.72 percent. While this is below the supervised trajectory, the performance gap is modest: at 41.72 percent training data, pseudo-labelled 1403 achieves 73.67 compared to the supervised 1402 curve at approximately 75.04 (a gap of ˜1.4 percentage points). At the upper bound shown, supervised training reaches 76.54, yielding an overall maximum advantage of ˜2.9 percentage points compared to pseudo-labelled training.

The comparison between supervised 1402 and pseudo-labelled 1403 illustrates an important trade-off: supervised training remains optimal in terms of absolute mAP, but pseudo-labelling enables accuracy gains with minimal human annotation. This is consistent with earlier findings in FIG. 11 (diminishing returns with additional labels) and FIG. 12 (coreset efficiency), underscoring that pseudo-labelling provides a scalable mechanism for improving detection accuracy when manual labeling resources are constrained.

Accordingly, FIG. 15 demonstrates that while supervised annotation yields the best accuracy, semi-supervised training with pseudo-labels offers a cost-effective and scalable path to model improvement, particularly in engineering domains where large-scale manual labeling of P&ID diagrams is prohibitive.

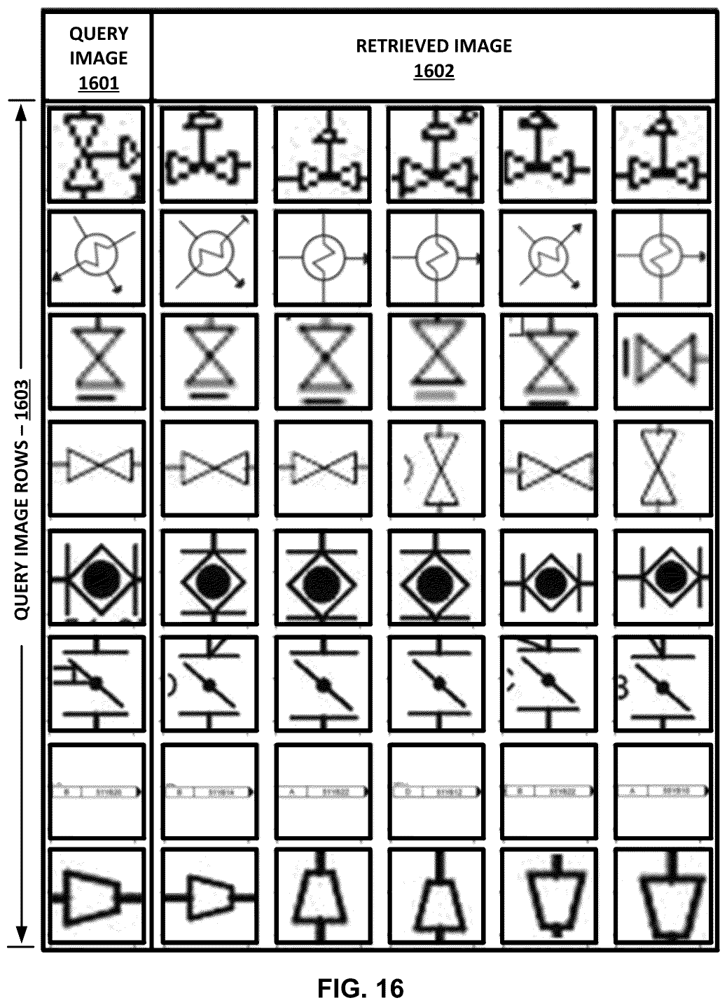

FIG. 16 illustrates symbol retrieval results produced by symbol detection framework 170, showing performance of the trained Siamese network across multiple query cases, in accordance with aspects of the disclosure. The figure is organized as a matrix where each horizontal row corresponds to a unique query image 1601, positioned at the leftmost column of the row. Each subsequent cell in that row presents a retrieved image 1602. Each row thus represents one complete query image row 1603, composed of one query image 1601 and several associated retrieved image 1602 instances.

Each query image 1601 corresponds to a unique P&ID symbol type drawn from a set of 102 distinct classes. For each query image 1601, symbol detection framework 170 utilizes a similarity-based image retrieval method to return a ranked list of the most visually and semantically similar images. The results demonstrate the output of the Siamese network trained using 10,000 triplets of symbol image pairs, as described in FIG. 9.

The retrieved image 1602 results show strong correlation in visual structure and semantics with the corresponding query image 1601, confirming that the Siamese network has successfully learned a meaningful embedding space for symbol comparison. Despite variations in stroke thickness, orientation, distortion, and rendering noise, the retrieved image 1602 results maintain high fidelity with the intended symbol category.

Each query image row 1603 demonstrates the consistent ability of symbol detection framework 170 to identify the correct symbol family, regardless of symbol complexity or stylistic variance. This is significant given that the 102 symbol categories span a broad range of industrial diagram elements such as control valves, flow sensors, measurement indicators, and signal converters.

Accordingly, FIG. 16 illustrates that symbol detection framework 170, leveraging the Siamese network, provides accurate and robust visual retrieval of symbol classes under noisy or imperfect imaging conditions. The method supports downstream applications such as symbol clustering, automated tagging, and schema recovery across scanned or digitally authored engineering diagrams. In some examples, retrieval accuracy may be further improved when used in combination with pseudo-labeling to expand training coverage or negative sampling strategies to refine embedding separation, thereby complementing the retrieval results demonstrated in FIG. 16.

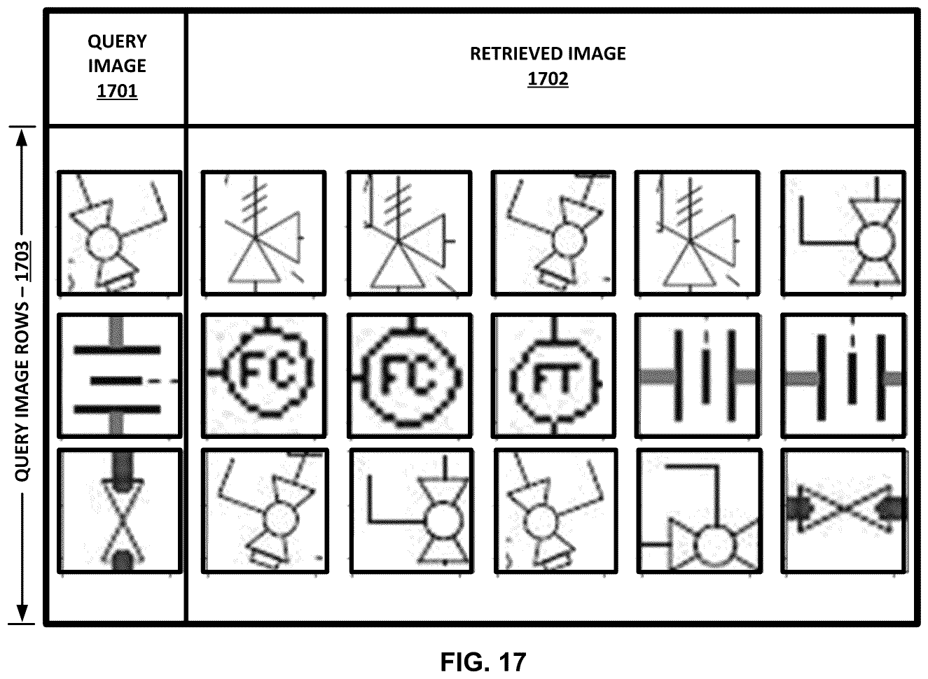

FIG. 17 depicts instances where symbol detection framework 170 may require further training or a more diverse dataset due to unsuccessful retrieval from respective query image 1701, in accordance with aspects of the disclosure. Each query image 1701 is shown in a row of query image rows 1703, where a corresponding set of retrieved image 1702 instances are displayed. The retrieved image 1702 instances illustrate results generated by symbol detection framework 170 following inference from each respective query image 1701. In several rows of query image rows 1703, the retrieved image 1702 does not visually or semantically match the query image 1701, indicating that symbol detection framework 170 did not retrieve symbols from the same symbol class.

Despite these retrieval errors, the model of symbol detection framework 170 achieves a Top-1 accuracy of 85.39% and a Top-5 accuracy of 95.19% when evaluated on a test dataset consisting of 102 P&ID symbol classes. This performance level demonstrates the high baseline accuracy of symbol detection framework 170, even in the absence of supervised learning signals.

The model of symbol detection framework 170 relies on a self-supervised learning methodology without the use of class labels or human-provided annotations. This distinguishes symbol detection framework 170 from fully supervised methods, which typically achieve classification accuracies of 97% and above but require extensive manual labeling and curation of training data. In contrast, symbol detection framework 170 generates useful embeddings through unsupervised learning, effectively eliminating the need for human expert involvement during the training phase.

To further improve retrieval quality in scenarios such as those shown in FIG. 17, symbol detection framework 170 may be enhanced using a human-in-the-loop (HITL) mechanism. In this approach, a human operator could review and refine incorrectly retrieved triplets identified during inference, allowing for the creation of a curated triplet dataset. These curated triplets can then be used to fine-tune the Siamese network used in symbol detection framework 170, introducing beneficial human oversight during training while still avoiding the overhead of full annotation. A model trained using HITL may better generalize to diverse symbol drawing styles and thus support reliable differentiation across a broader range of symbol classes.

Symbol detection framework 170 as disclosed enables automatic operation without human intervention in certain examples, while still attaining performance results comparable to those produced by fully supervised learning systems. This advantage addresses a key limitation in known approaches, which are constrained by the high cost and low scalability of manual data annotation.

Symbol detection framework 170 may also be extended to enable complete document-level analysis of piping and instrumentation diagrams (P&IDs), including the detection of pipeline connectivity, textual labels, and inter-symbol relationships.

In addition to HITL, symbol detection framework 170 can be improved using enhanced fine-tuning methodologies. For example, the pretrained model used in symbol detection framework 170 may serve as a foundational backbone for domain-specific refinement, overcoming limitations encountered when using models trained on generic datasets such as the Omniglot model. Furthermore, extending symbol detection framework 170 to process RGB images may allow the system to exploit richer input modalities, especially when interpreting color-based or stylistically diverse engineering drawings.

To mitigate challenges related to class imbalance and ineffective negative sampling, symbol detection framework 170 may incorporate hard negative mining techniques, whereby the most ambiguous or confusing negative examples are intentionally used during training. In parallel, adaptive margin triplet loss may be applied to dynamically adjust the training objective based on intra-class and inter-class distances, thereby improving embedding separation and boosting model precision.

Additional optimization strategies for symbol detection framework 170 include the use of pretrained convolutional backbones obtained from large-scale datasets such as MS COCO. Prior results demonstrate that using MS COCO pretrained weights resulted in a mean average precision (mAP) of 84.8%, validating the importance of transfer learning in model initialization. Symbol detection framework 170 may incorporate these pretrained architectures as initialization checkpoints, accelerating convergence and improving feature representation in downstream P&ID tasks.

The relationship between annotation volume and model performance is known to be nonlinear. Consequently, data expansion via pseudo-labeling strategies may be tuned for greater efficiency, providing high utility with minimal human effort. Pseudo-labeled samples may be prioritized based on uncertainty, representativeness, or model disagreement, enabling iterative refinement of the training dataset.

Overall, the symbol detector of symbol detection framework 170, which already achieves a Top-1 accuracy of 85.39% and a Top-5 accuracy of 95.19% on a diverse dataset of 102 P&ID symbol classes, may be further optimized through configuration enhancements as described above. These improvements may yield greater accuracy while maintaining the model's strong advantage of requiring zero or minimal manual annotation effort. In particular, the incorporation of pseudo-labeling strategies, uncertainty-driven sample selection, and hard negative mining can provide targeted performance boosts, enabling the framework to reduce retrieval errors of the type shown in FIG. 17 while preserving scalability.

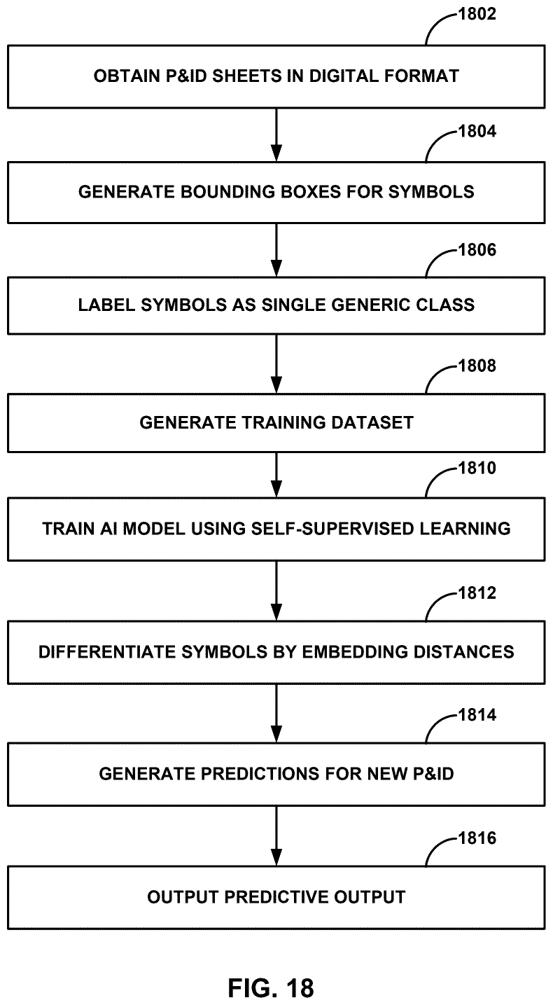

FIG. 18 is a flow diagram illustrating an example method for training and applying an artificial intelligence (AI) model to identify and differentiate symbols from piping and instrumentation diagram (P&ID) sheets, in accordance with aspects of the disclosure. FIG. 18 is described with respect to computing device 100 and systems or processing circuitry as described in relation to FIGS. 1-17. However, the techniques of FIG. 18 may be performed by different components of computing device 100 or by additional or alternative systems.

Processing circuitry of computing device 100 may be configured to obtain P&ID sheets in digital format (1802). For example, the processing circuitry may be configured to obtain, by a computer system, a plurality of P&ID sheets in a digital format.

Processing circuitry of computing device 100 may be configured to generate bounding boxes for symbols (1804). For example, the processing circuitry may be configured to localize symbols from the P&ID sheets by generating bounding boxes for the symbols.

Processing circuitry of computing device 100 may be configured to label symbols as a single generic class (1806). For example, the processing circuitry may be configured to label the symbols localized from the P&ID sheets as a single generic class.

Processing circuitry of computing device 100 may be configured to generate a training dataset (1808). For example, the processing circuitry may be configured to generate a training dataset using the symbols localized from the P&ID sheets and labeled as the single generic class.

Processing circuitry of computing device 100 may be configured to an train AI model using self-supervised learning (1810). For example, the processing circuitry may be configured to train an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols.

Processing circuitry of computing device 100 may be configured to differentiate symbols by embedding distances (1812). For example, the processing circuitry may be configured to use the trained artificial intelligence model to differentiate among the symbols in the training dataset based on the distances between embeddings of the symbols.

Processing circuitry of computing device 100 may be configured to generate predictions for new P&ID (1814). For example, the processing circuitry may be configured to generate predictive output using the artificial intelligence model trained on the training dataset for describing symbols within a new P&ID sheet which forms no part of the training dataset.

Processing circuitry of computing device 100 may be configured to output predictive output (1816). For example, the processing circuitry may be configured to output the predictive output generated for the new P&ID sheet.

In some implementations, the process of FIG. 18 may further incorporate coreset sampling, iterative pseudo-labeling, and human-in-the-loop refinements to enhance efficiency and accuracy. For example, compact latent embeddings generated by an autoencoder can be clustered to select representative samples through K-means coreset sampling, thereby reducing redundancy in training data while preserving diversity. Iterative pseudo-labeling may expand the training dataset in staged increments, such as by adding 10% batches of confidently inferred labels at each iteration, allowing the model to bootstrap performance without introducing excessive confirmation bias. In addition, a human-in-the-loop mechanism may be employed to review uncertain or misclassified symbols during inference, providing curated corrections that fine-tune the Siamese network and strengthen generalization. Together, these extensions complement the self-supervised training loop of FIG. 18, enabling symbol detection framework 170 to achieve improved scalability, annotation efficiency, and retrieval accuracy across diverse P&ID diagram sources.

In this way, FIG. 18 illustrates an example process for using self-supervised learning to train an AI model that enables the automated detection, representation, and prediction of symbols in previously unseen P&ID diagrams. Unlike conventional pipelines that require extensive class-specific labeling, the illustrated process labels symbols as a single generic class and relies on self-supervised embedding learning to capture semantic differentiation among symbol categories. The training dataset may be further refined using strategies such as coreset sampling (see FIG. 12), embedding coverage optimization (see FIGS. 13A-13B), and pseudo-labeling expansion (see FIGS. 14-15). The trained model then supports similarity-based retrieval and classification of symbols (see FIGS. 16-17). Collectively, this pipeline enables intelligent, scalable analysis of complex technical schematics with reduced manual labeling requirements, while also supporting extensibility to human-in-the-loop refinement and transfer learning from external datasets.

This disclosure includes the following examples.

Example 1—A method comprising: obtaining, by a computer system, a plurality of Piping and Instrumentation Diagram (P&ID) sheets in a digital format; localizing symbols from the P&ID sheets by generating bounding boxes for the symbols; labeling the symbols localized from the P&ID sheets as a single generic class; generating a training dataset using the symbols localized from the P&ID sheets and labeled as the single generic class; training, by the computer system, an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols; generating predictive output using the artificial intelligence model trained on the training dataset for describing symbols within a new P&ID sheet which forms no part of the training dataset; and outputting the predictive output.

Example 2—The method of example 1, wherein generating the training dataset includes splitting each one of the Piping and Instrumentation Diagram (P&ID) sheets into a grid of non-overlapping cropped samples; wherein the method further comprises: pre-processing the non-overlapping cropped samples from each one of the P&ID sheets to remove any empty crops among the non-overlapping cropped samples; and compiling the training dataset from non-empty crops among the non-overlapping cropped samples with diverse drawing styles of the symbols to improve generalization of the artificial intelligence model to new inputs which form no part of the training dataset.

Example 3—The method of example 1, further comprising: training the artificial intelligence model with self-supervised learning including generating pseudo-labels for an expanded training dataset by utilizing the artificial intelligence model trained on the training dataset to predict labels for unlabeled data; and retraining the artificial intelligence model using both the training dataset and the pseudo-labels for the expanded training dataset to increase symbol differentiation performance of the artificial intelligence model subsequent to retraining.

Example 4—The method of example 1, further comprising: training the artificial intelligence model with self-supervised learning using a Siamese network to learn the distinctive features and to differentiate among the symbols in the training dataset by minimizing the distance between embeddings of similar symbols and maximizing the distance between embeddings of dissimilar symbols.

Example 5—The method of example 4, further comprising: training the Siamese network with triplets having an anchor image, a positive image, and a negative image; wherein the anchor image and the positive image are from a same class; and wherein the negative image is from a different class, using a triplet loss function to refine the Siamese network to differentiate symbols.

Example 6—The method of example 5, further comprising: training the Siamese network using the triplet loss function to minimize a Euclidean distance between the embeddings of the anchor image and the positive image while maximizing the Euclidean distance between the embeddings of the anchor image and the negative image to increase symbol differentiation of the artificial intelligence model.

Example 7—The method of example 1, further comprising: performing generic symbol detection on the P&ID sheets to: localize the symbols from the P&ID sheets; and initially label the symbols as the single generic class to negate any human manual annotation of the symbols.

Example 8—The method of example 1, wherein the predictive output generated for the new P&ID sheet includes one or more of: one or more pipelines between the symbols within the new P&ID sheet; directionality of the one or more pipelines within the new P&ID sheet; text annotations associated with one or more of the symbols within the new P&ID sheet; one or more valve locations associated with any of the one or more symbols or the one or more pipelines within the new P&ID sheet; one or more instrumentation sensors, instrumentation transmitters, or instrumentation controllers associated with any of the one or more symbols or the one or more pipelines within the new P&ID sheet; and one or more control loops or process signals for system operations described by the new P&ID sheet.

Example 9—The method of example 1, wherein the new P&ID sheet includes at least one of: an image scanned from paper; or a digital Portable Document Format (PDF) file lacking metadata describing the symbols.

Example 10—The method of example 1, wherein generating the training dataset includes splitting each one of the P&ID sheets into a grid of non-overlapping cropped samples; and wherein each one of the non-overlapping cropped samples has a size pre-configured to reduce computational requirements to process the non-overlapping cropped samples without reducing prediction accuracy of the artificial intelligence model.

Example 11—The method of example 1, further comprising: displaying a graphical user interface for presenting the predictive output and receiving user feedback on symbol correctness.

Example 12—The method of example 1, further comprising: receiving human-verified corrections to the predictive output and updating the training dataset with corrected symbol labels; and retraining the artificial intelligence model using the updated training dataset to improve symbol differentiation performance.

Example 13—The method of example 1, further comprising: generating a base entity graph from the plurality of Piping and Instrumentation Diagram (P&ID) sheets, the base entity graph including nodes representing symbols, nodes representing line crossings, and edges representing pipelines.

Example 14—The method of example 13, further comprising: transforming the base entity graph into a labeled property graph by appending node properties including class, location, alias, and tag to the nodes of the base entity graph.

Example 15—The method of example 14, further comprising: receiving a natural language query; converting the natural language query into a graph query language compatible with the labeled property graph; executing the graph query language against the labeled property graph; and returning a natural language response based on results of the executed graph query language.

Example 16—A system comprising: processing circuitry; non-transitory computer readable media; and instructions that, when executed by the processing circuitry, configure the processing circuitry to: obtain, by the processing circuitry, a plurality of Piping and Instrumentation Diagram (P&ID) sheets in a digital format; localize, by the processing circuitry, symbols from the P&ID sheets by generating bounding boxes for the symbols; label, by the processing circuitry, the symbols localized from the P&ID sheets as a single generic class; generate, by the processing circuitry, a training dataset using the symbols localized from the P&ID sheets and labeled as the single generic class; train, by the processing circuitry, an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols; generate, by the processing circuitry, predictive output using the artificial intelligence model trained on the training dataset for describing symbols within a new P&ID sheet which forms no part of the training dataset; and output, by the processing circuitry, the predictive output.

Example 17—The system of example 16, wherein to generate the training dataset includes the processing circuitry further configured to: split each one of the Piping and Instrumentation Diagram (P&ID) sheets into a grid of non-overlapping cropped samples; pre-process, by the processing circuitry, the non-overlapping cropped samples from each one of the P&ID sheets to remove any empty crops among the non-overlapping cropped samples; and compile, by the processing circuitry, the training dataset from non-empty crops among the non-overlapping cropped samples with diverse drawing styles of the symbols to improve generalization of the artificial intelligence model to new inputs which form no part of the training dataset.

Example 18—The system of example 16, wherein the instructions, when executed by the processing circuitry, further configure the processing circuitry to: train, by the processing circuitry, the artificial intelligence model with self-supervised learning including generating pseudo-labels for an expanded training dataset by utilizing the artificial intelligence model trained on the training dataset to predict labels for unlabeled data; and retrain, by the processing circuitry, the artificial intelligence model using both the training dataset and the pseudo-labels for the expanded training dataset to increase symbol differentiation performance of the artificial intelligence model subsequent to retraining.

Example 19—The system of example 16, wherein the instructions, when executed by the processing circuitry, further configure the processing circuitry to: train, by the processing circuitry, the artificial intelligence model with self-supervised learning using a Siamese network to learn the distinctive features and to differentiate among the symbols in the training dataset by minimizing the distance between embeddings of similar symbols and maximizing the distance between embeddings of dissimilar symbols.

Example 20—Computer-readable storage media comprising instructions that, when executed, configure processing circuitry to: obtain a plurality of Piping and Instrumentation Diagram (P&ID) sheets in a digital format; localize symbols from the P&ID sheets by generating bounding boxes for the symbols; label the symbols localized from the P&ID sheets as a single generic class; generate a training dataset using the symbols localized from the P&ID sheets and labeled as the single generic class; train an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols; generate predictive output using the artificial intelligence model trained on the training dataset for describing symbols within a new P&ID sheet which forms no part of the training dataset; and output the predictive output.

Example 21—A computer program product comprising one or more instructions that, when executed by at least one processor, cause the at least one processor to perform any of the methods of examples 1-15.

Example 22—A device comprising means for performing any of the methods of examples 1-15.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
obtaining, by a computer system, a plurality of Piping and Instrumentation Diagram (P&ID) sheets in a digital format;
localizing symbols from the P&ID sheets by generating bounding boxes for the symbols;
labeling the symbols localized from the P&ID sheets as a single generic class;
generating a training dataset using the symbols localized from the P&ID sheets and labeled as the single generic class;
training, by the computer system, an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols;
generating predictive output using the artificial intelligence model trained on the training dataset for describing symbols within a new P&ID sheet which forms no part of the training dataset; and
outputting the predictive output.

2. The method of claim 1, wherein generating the training dataset includes splitting each one of the Piping and Instrumentation Diagram (P&ID) sheets into a grid of non-overlapping cropped samples;
wherein the method further comprises:
pre-processing the non-overlapping cropped samples from each one of the P&ID sheets to remove any empty crops among the non-overlapping cropped samples; and
compiling the training dataset from non-empty crops among the non-overlapping cropped samples with diverse drawing styles of the symbols to improve generalization of the artificial intelligence model to new inputs which form no part of the training dataset.

3. The method of claim 1, further comprising:
training the artificial intelligence model with self-supervised learning including generating pseudo-labels for an expanded training dataset by utilizing the artificial intelligence model trained on the training dataset to predict labels for unlabeled data; and
retraining the artificial intelligence model using both the training dataset and the pseudo-labels for the expanded training dataset to increase symbol differentiation performance of the artificial intelligence model subsequent to retraining.

4. The method of claim 1, further comprising:
training the artificial intelligence model with self-supervised learning using a Siamese network to learn the distinctive features and to differentiate among the symbols in the training dataset by minimizing the distance between embeddings of similar symbols and maximizing the distance between embeddings of dissimilar symbols.

5. The method of claim 4, further comprising:
training the Siamese network with triplets having an anchor image, a positive image, and a negative image;
wherein the anchor image and the positive image are from a same class; and
wherein the negative image is from a different class, using a triplet loss function to refine the Siamese network to differentiate symbols.

6. The method of claim 5, further comprising:
training the Siamese network using the triplet loss function to minimize a Euclidean distance between the embeddings of the anchor image and the positive image while maximizing the Euclidean distance between the embeddings of the anchor image and the negative image to increase symbol differentiation of the artificial intelligence model.

7. The method of claim 1, further comprising:
performing generic symbol detection on the P&ID sheets to:
localize the symbols from the P&ID sheets; and
initially label the symbols as the single generic class to negate any human manual annotation of the symbols.

8. The method of claim 1, wherein the predictive output generated for the new P&ID sheet includes one or more of:
one or more pipelines between the symbols within the new P&ID sheet;
directionality of the one or more pipelines within the new P&ID sheet;
text annotations associated with one or more of the symbols within the new P&ID sheet;
one or more valve locations associated with any of the one or more symbols or the one or more pipelines within the new P&ID sheet;
one or more instrumentation sensors, instrumentation transmitters, or instrumentation controllers associated with any of the one or more symbols or the one or more pipelines within the new P&ID sheet; and
one or more control loops or process signals for system operations described by the new P&ID sheet.

9. The method of claim 1, wherein the new P&ID sheet includes at least one of:
an image scanned from paper; or
a digital Portable Document Format (PDF) file lacking metadata describing the symbols.

10. The method of claim 1, wherein generating the training dataset includes splitting each one of the P&ID sheets into a grid of non-overlapping cropped samples; and
wherein each one of the non-overlapping cropped samples has a size pre-configured to reduce computational requirements to process the non-overlapping cropped samples without reducing prediction accuracy of the artificial intelligence model.

11. The method of claim 1, further comprising:
displaying a graphical user interface for presenting the predictive output and receiving user feedback on symbol correctness.

12. The method of claim 1, further comprising:
receiving human-verified corrections to the predictive output and updating the training dataset with corrected symbol labels; and
retraining the artificial intelligence model using the updated training dataset to improve symbol differentiation performance.

13. The method of claim 1, further comprising:
generating a base entity graph from the plurality of Piping and Instrumentation Diagram (P&ID) sheets, the base entity graph including nodes representing symbols, nodes representing line crossings, and edges representing pipelines.

14. The method of claim 13, further comprising:
transforming the base entity graph into a labeled property graph by appending node properties including class, location, alias, and tag to the nodes of the base entity graph.

15. The method of claim 14, further comprising:
receiving a natural language query;
converting the natural language query into a graph query language compatible with the labeled property graph;
executing the graph query language against the labeled property graph; and
returning a natural language response based on results of the executed graph query language.

16. A system comprising:
processing circuitry;
non-transitory computer readable media; and
instructions that, when executed by the processing circuitry, configure the processing circuitry to:
obtain, by the processing circuitry, a plurality of Piping and Instrumentation Diagram (P&ID) sheets in a digital format;
localize, by the processing circuitry, symbols from the P&ID sheets by generating bounding boxes for the symbols;
label, by the processing circuitry, the symbols localized from the P&ID sheets as a single generic class;
generate, by the processing circuitry, a training dataset using the symbols localized from the P&ID sheets and labeled as the single generic class;
train, by the processing circuitry, an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols;
generate, by the processing circuitry, predictive output using the artificial intelligence model trained on the training dataset for describing symbols within a new P&ID sheet which forms no part of the training dataset; and
output, by the processing circuitry, the predictive output.

17. The system of claim 16, wherein to generate the training dataset includes the processing circuitry further configured to:
split each one of the Piping and Instrumentation Diagram (P&ID) sheets into a grid of non-overlapping cropped samples;
pre-process, by the processing circuitry, the non-overlapping cropped samples from each one of the P&ID sheets to remove any empty crops among the non-overlapping cropped samples; and
compile, by the processing circuitry, the training dataset from non-empty crops among the non-overlapping cropped samples with diverse drawing styles of the symbols to improve generalization of the artificial intelligence model to new inputs which form no part of the training dataset.

18. The system of claim 16, wherein the instructions, when executed by the processing circuitry, further configure the processing circuitry to:
train, by the processing circuitry, the artificial intelligence model with self-supervised learning including generating pseudo-labels for an expanded training dataset by utilizing the artificial intelligence model trained on the training dataset to predict labels for unlabeled data; and
retrain, by the processing circuitry, the artificial intelligence model using both the training dataset and the pseudo-labels for the expanded training dataset to increase symbol differentiation performance of the artificial intelligence model subsequent to retraining.

19. The system of claim 16, wherein the instructions, when executed by the processing circuitry, further configure the processing circuitry to:
train, by the processing circuitry, the artificial intelligence model with self-supervised learning using a Siamese network to learn the distinctive features and to differentiate among the symbols in the training dataset by minimizing the distance between embeddings of similar symbols and maximizing the distance between embeddings of dissimilar symbols.

20. Computer-readable storage media comprising instructions that, when executed, configure processing circuitry to:
obtain a plurality of Piping and Instrumentation Diagram (P&ID) sheets in a digital format;
localize symbols from the P&ID sheets by generating bounding boxes for the symbols;
label the symbols localized from the P&ID sheets as a single generic class;
generate a training dataset using the symbols localized from the P&ID sheets and labeled as the single generic class;
train an artificial intelligence model using self-supervised learning on the training dataset to enable learning of distinctive features of the symbols in the training dataset and to differentiate among the symbols in the training dataset by minimizing a distance between embeddings of similar symbols and maximizing the distance between embeddings of dissimilar symbols;
generate predictive output using the artificial intelligence model trained on the training dataset for describing symbols within a new P&ID sheet which forms no part of the training dataset; and
output the predictive output.
